(19) United States
(12) Patent Application Publication
(10) Pub. No.: US 2001/0049648 A1
(43) Pub. Date: Dec. 6, 2001

(54) Electronic marketplace for auctioning non-exclusive rights in intangible property

(76) Inventors: Richard Naylor, Washington, DC (US); David Room, Oakland, CA (US); Craig Herndon, Annapolis, MD (US); Eric Yeager, Washington, DC (US); Robert Herndon, Annandale, VA (US)

Correspondence Address: PENNIE & EDMONDS LLP, 1667 K STREET NW, SUITE 1000, WASHINGTON, DC, 20006

(21) Appl. No.: 09/782,277

(22) Filed: Feb. 14, 2001

Related U.S. Application Data
(60) Provisional application No. 60/182,533, filed on Feb. 15, 2000.
(60) Provisional application No. 60/209,589, filed on Jun. 6, 2000.

(51) Int. Cl. G06F 17/60

(52) U.S. Cl. 705/37

(57) ABSTRACT

An electronic marketplace for selling and auctioning off display rights to digital imagery. Photographers upload digital images to a web site run by an auction house and specify the terms and conditions under which they are willing to allow others to display the digital images. Prospective buyers, who have registered with the auction house can view these digital images, and bid for the right to display the images. Various exclusive and non-exclusive display rights are offered, and various auctions and pricing schemes are offered, and the buyers are selected from the bidders according to one of a number of candidate auction algorithms, depending on the objectives of the auction house and the photographer.

### RELATED APPLICATIONS

This application claims priority to U.S. Provisional Application No. 60/182,533 filed on Feb. 15, 2000, and Ser. No. 60/209,589, filed on Jun. 6, 2000.

### TECHNICAL FIELD

The present invention is directed to an electronic marketplace for licensing rights in intangible property such as copyrights, trademarks and patents. More particularly, it is directed to such a marketplace in which one or more rights in the intangible property are auctioned and/or sold to consumers in a manner which maximizes revenue.

### BACKGROUND

There are several types of intangible property which are recognized as having value to their owners and licensees. Included among these are copyrights, trademarks and patents. One thing that these types of intangible property have in common is that they can be licensed on either an exclusive basis, or on a non-exclusive basis, according to the owner's preference.

A copyright is a bundle of rights associated with an original work of art that is fixed in a tangible medium of expression. The copyright bundle includes such things as the right to display, right to public performance, and right to prepare derivative works, among others. These rights can be allocated and exploited in any manner that the copyright holder wishes. In the case of a photograph, for example, a photographer may sell both exclusive and non-exclusive copyright rights under different terms and conditions. These terms and conditions can include, for example, temporal conditions, number of copies licensed, geographic conditions, rights to make derivative works, and the like. For instance, the photographer may sell exclusive rights to one news organization to publish the photograph on the first day, and non-exclusive rights to the same and/or other news organizations for publication thereafter. Additional rights, such as the right to use that photograph on a T-shirt, a coffee cup, or even display it on a billboard, may be separately traded, at the photographer's choosing. In the case of a book, rights to publicly display the work, rights to prepare derivative works such as movies or plays, and other rights, as well, may be sold on either exclusive or non-exclusive bases.

A trademark is an indicia which associates a product or service with a particular source or origin. While many trademarks are used only by their owner, trademarks can also be licensed on a non-exclusive basis, as exemplified by the numerous designer labels affixed to a wide variety of goods.

A patent is a right to exclude another from making, using, selling, offering for sale, or importing the claimed invention. A patent may be licensed, either on an exclusive basis, or on a non-exclusive basis, with the owner specifying such things as a geographical area in which the patent may be exploited, a field of use, or other terms to which the licensee agrees.

The internet, and especially that portion of the internet which uses the HTML markup language, commonly referred to as the “world wide web”, has provided electronic marketplaces for a wide variety of goods and services. Included among these are web-sites in which both tangible and intangible property is exchanged. In some of these marketplaces, goods or services have a fixed priced while in others, the goods and services are auctioned.

In the case of photographs, current web sites typically have a price schedule for photographs, based on the type of medium in which the photograph would be published (e.g., a newspaper, T-shirt, etc.) and the number of copies distributed. A photograph consumer may purchase the right to use a particular photograph and pay the asked-for price. However, current web sites offering photographs do not auction off various rights in intangible properties, especially the right to display digital images.

### SUMMARY OF THE INVENTION

In one aspect, the present invention is realized by an electronic marketplace in which an intangible right associated with a copyright, a trademark or a patent is auctioned off in a manner that maximizes revenue to the owner. If revenue is maximized by offering the right on an exclusive basis, then that right is sold exclusively to the highest bidder. If, on the other hand, revenue is maximized by selling the right to multiple bidders on a non-exclusive basis, then the right is sold to multiple bidders. Combinations of exclusive and non-exclusive rights may be offered for auction, and these are bid on by various parties. The winners of the auction comprise that set of parties whose choices do not conflict with one another and at the same time result in maximum revenue subject to one or more constraints, selected by either the right holder, the auction house, or the parties.

In another aspect, the present invention is directed to an electronic marketplace which offers photojournalistic, business-to-business, electronic commerce. The electronic marketplace of the present invention employs demand-based pricing to establish the true market value of photojournalistic-quality digital images.

### BRIEF DESCRIPTION OF THE DRAWINGS

The present invention can better be understood through the attached figures in which:

FIGS. 1-24 depict the web site design for an electronic marketplace in accordance with the present invention; and

FIG. 25 represents a flow chart of the steps executed to sell a digital image in accordance with the present invention.

### DETAILED DESCRIPTION OF THE PREFERRED EMBODIMENT

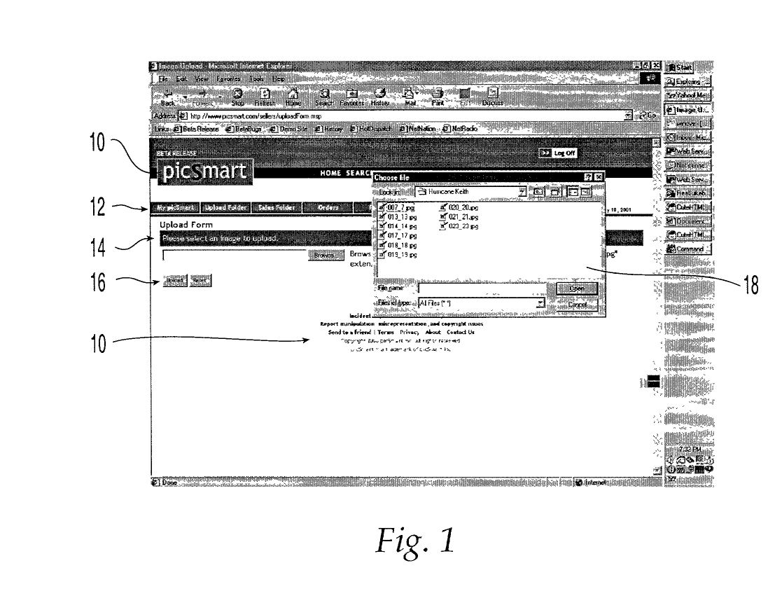

In a preferred embodiment, an electronic marketplace for photographers, in the form of a web site, is created. Attached FIGS. 1-24 illustrate the web design for a site called PICSMART™ hosting this electronic marketplace.

The electronic marketplace in one embodiment includes an auction house which represents a plurality of sellers of digital images, for example photographers, to assist the seller to find buyers for digital images created by these photographers. The electronic marketplace in another embodiment represents at least one buyer to assist the buyer to find sellers of digital images. The electronic marketplace in a third, preferred embodiment, acts as a neutral ground wherein both photographers and buyers are accredited and wherein there is a mechanism for interaction between the buyers and the sellers of the digital images created by a photographer which in a preferred embodiment provides for the sale of one or more rights in a digital image being transferred from a seller to a buyer.

Sellers of a digital image, typically a photographers or an entity representing at least one photographer, who wish to have photographs auctioned or sold via the electronic marketplace must first pass an accreditation process. They must first register with the auction house by providing identifying information and submitting the necessary forms to execute sales and payment contracts, releases, licenses, and the like. For example, the forms may include a license to convey any image put in a sales folder, wherein the seller receives a portion or all of the proceeds; various general or specific assignment agreements for those images the seller specifies are to be in the sales folder, agreement to hold the electronic marketplace harmless in the event a rights in a photo are sold or not sold; tax identification numbers and the like, and in one embodiment a form to determine whether the seller is given by the electronic marketplace a professional or a non-professional status. Preferably this paperwork is accomplished online through the use of digital signatures, although other means using account IDs and passwords, or even traditional documents, may also be used.

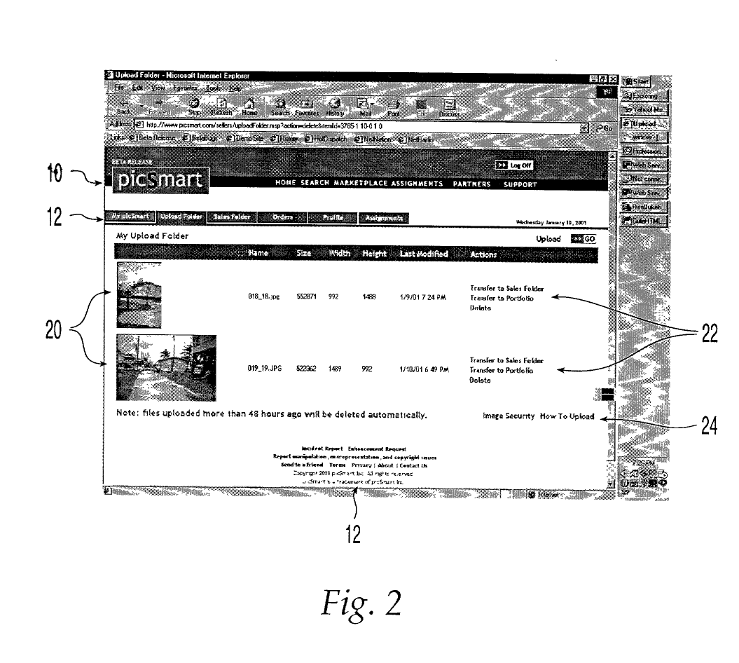

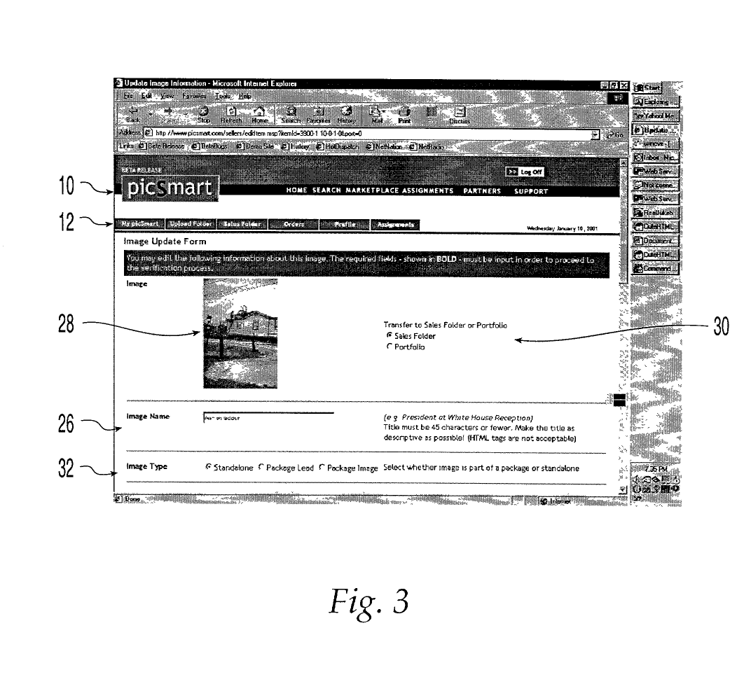

Once in the field, admitted photographers who utilize the auction house will upload photographs into the auction house's databases from all corners of the globe. FIG. 1 is an exemplary web page which asks the seller to title the uploaded image. It has a logo 10, a menu 12 from which the seller can navigate to other parts of the electronic marketplace, a location 14 to input the name of the uploaded image, a menu 16 which starts or cancels the upload, and a menu 18 from which the seller can select the image or images to upload. FIG. 2 is an exemplary web page which shows the seller which photos are in his/her upload folder along with pertinent information about the image in box 20, and a menu 22 to continue or cancel the upload, informational menus 24 regarding upload options. This page provides an option to transfer the image to a sales folder. FIG. 3 is an exemplary web page which has an input box 26 which asks the seller to title the uploaded image, a display 28 of the image, and a menu 30 to confirm the image is to go in a sales folder or optionally directs the image to a storage portfolio. Additionally, the seller in menu 32 is allowed to keep the image as a stand-alone offer or to group the image with other images in an offer for sale. These several steps, which requires affirmative actions on the part of the seller, are advantageous because placing the image in the sales folder may in some locals be construed as offering a item for sale. Advantageously, the logo 10 and navigating menus 12 are present in at least some form on each web page sent to either a buyer or seller.

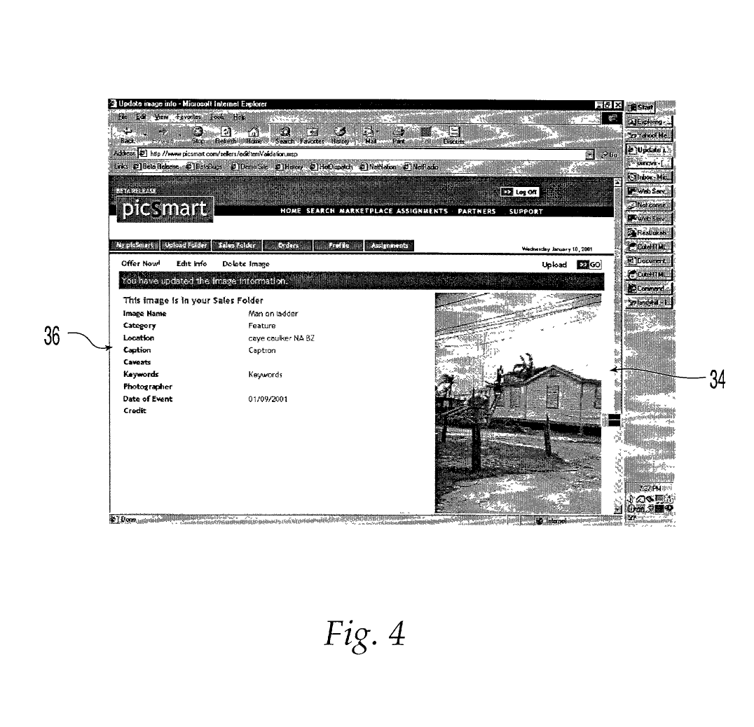

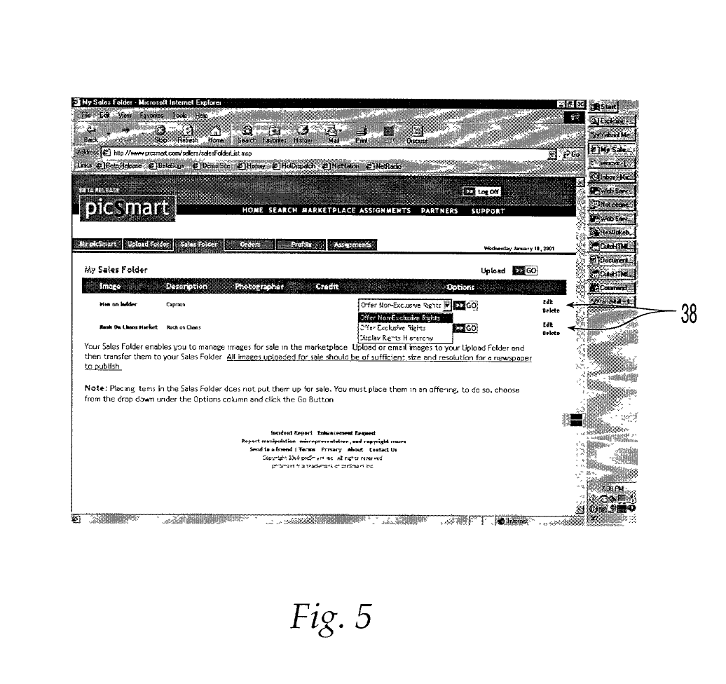

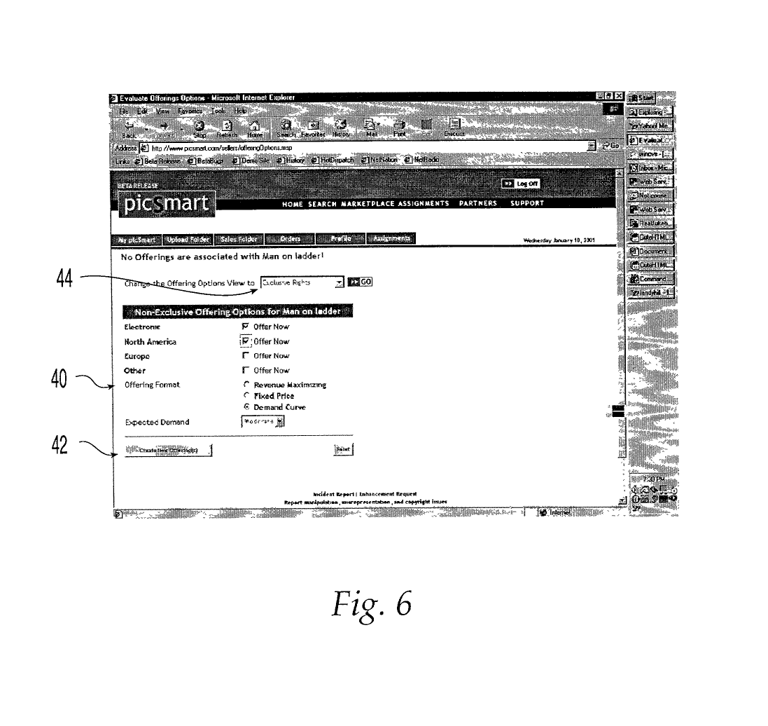

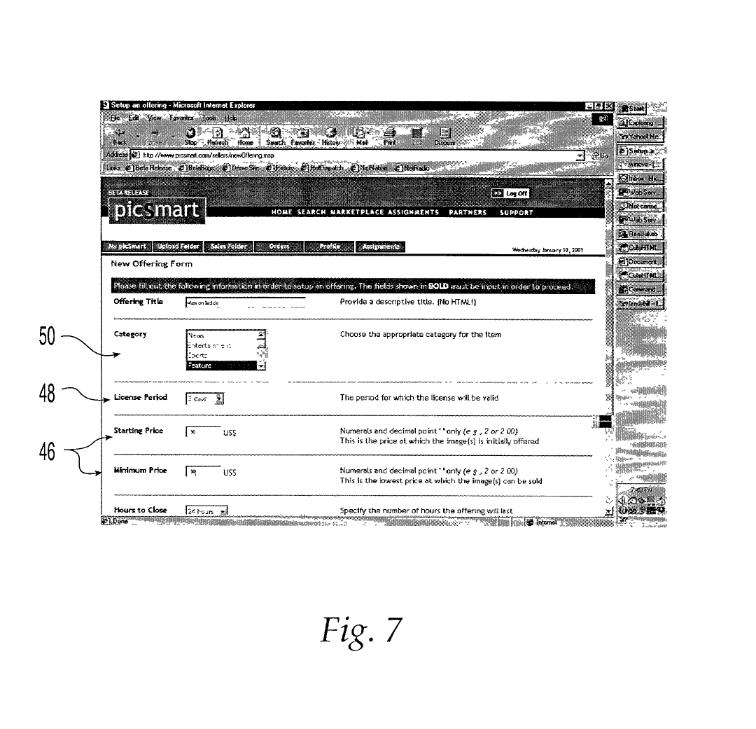

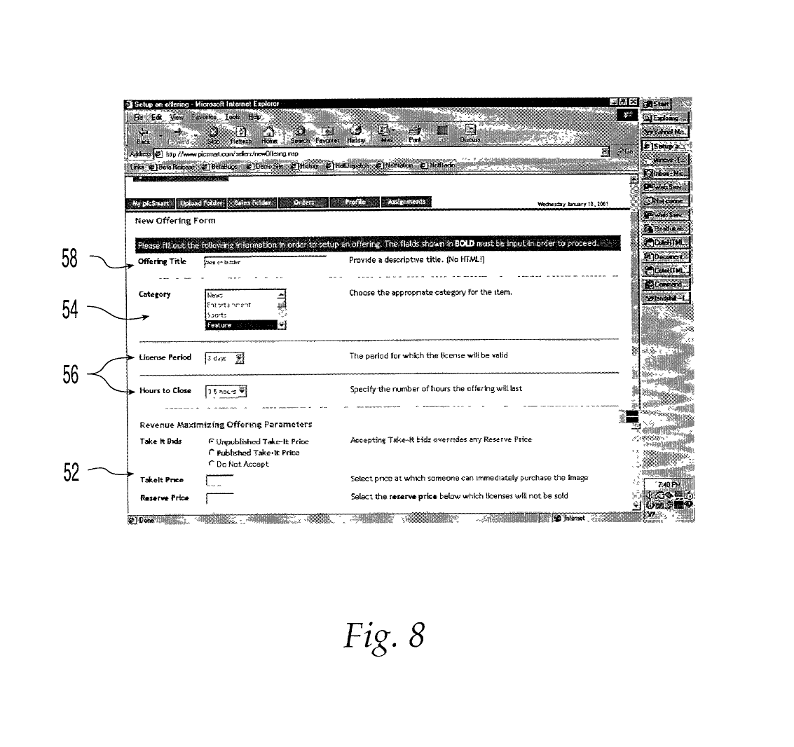

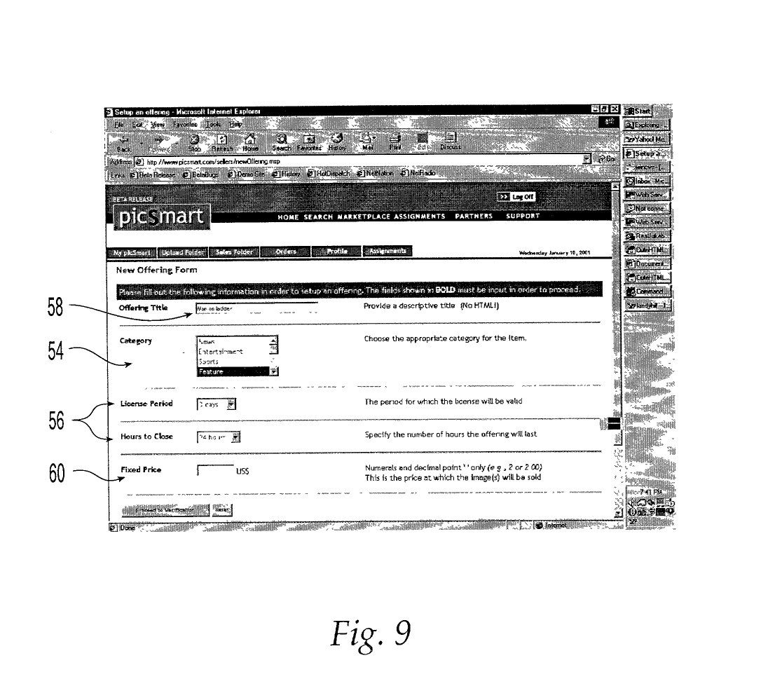

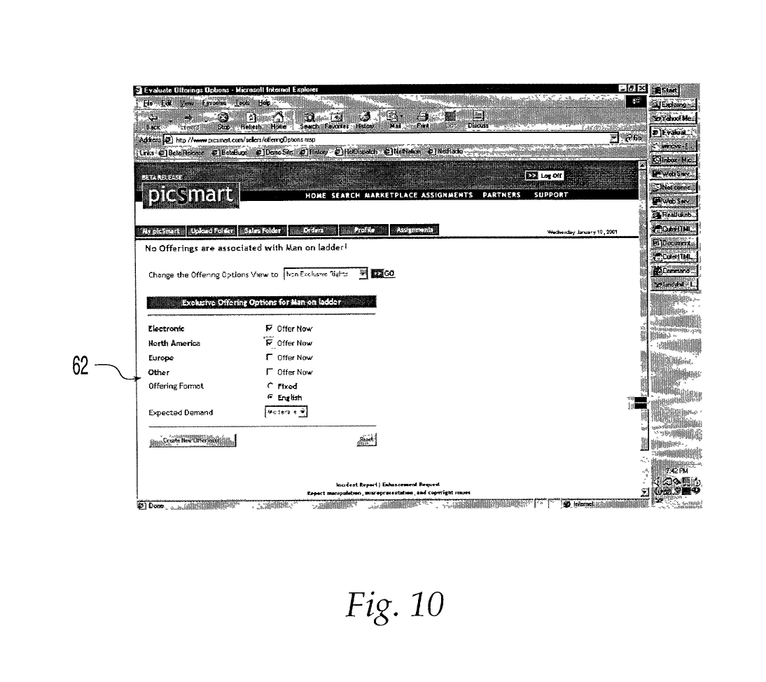

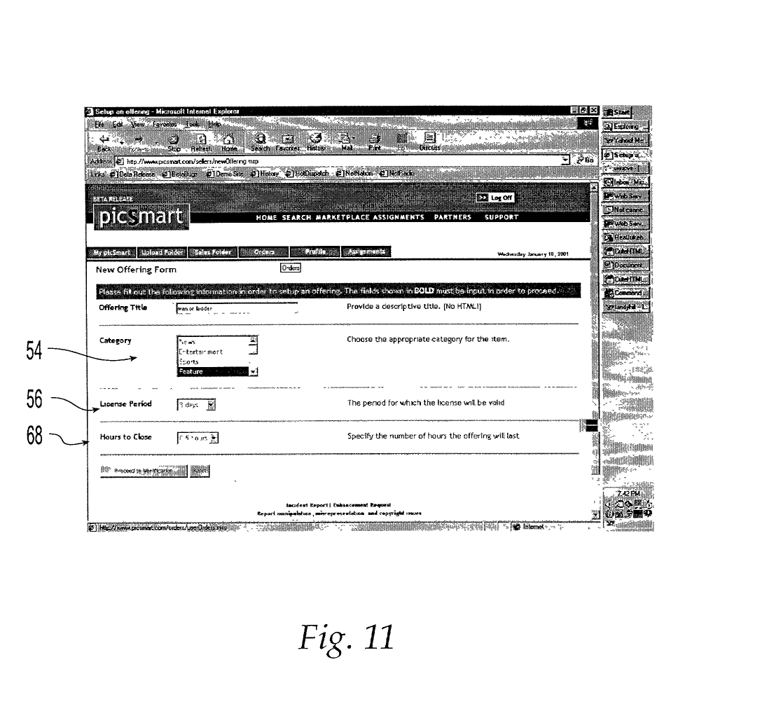

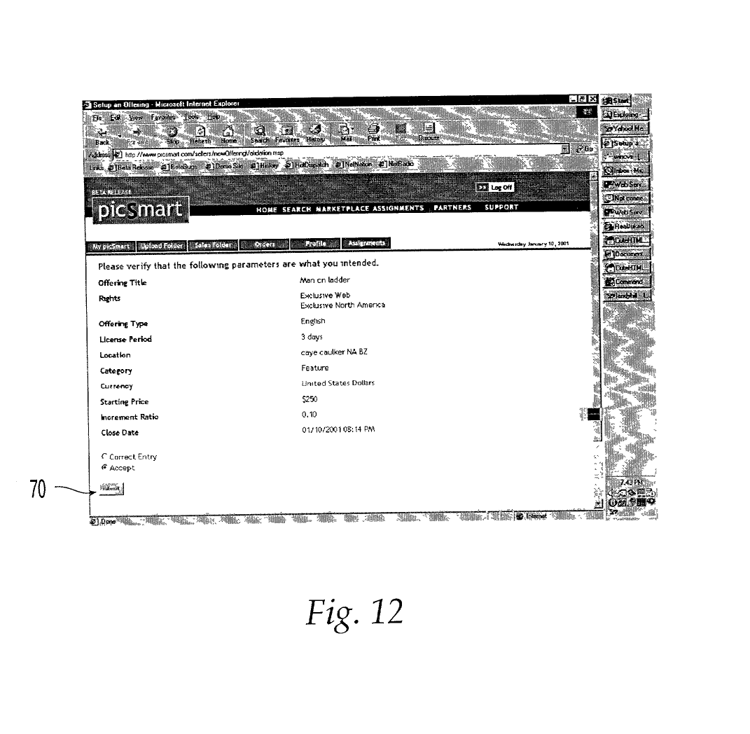

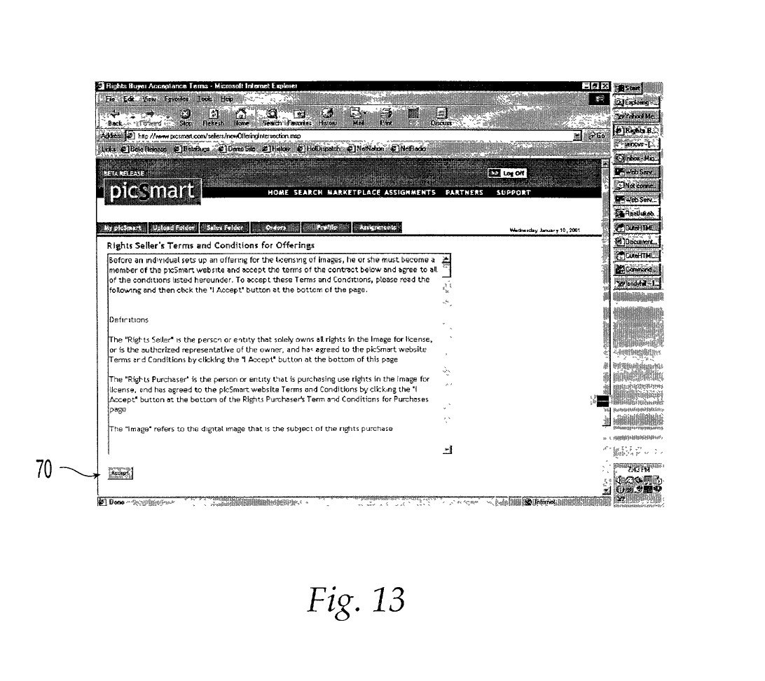

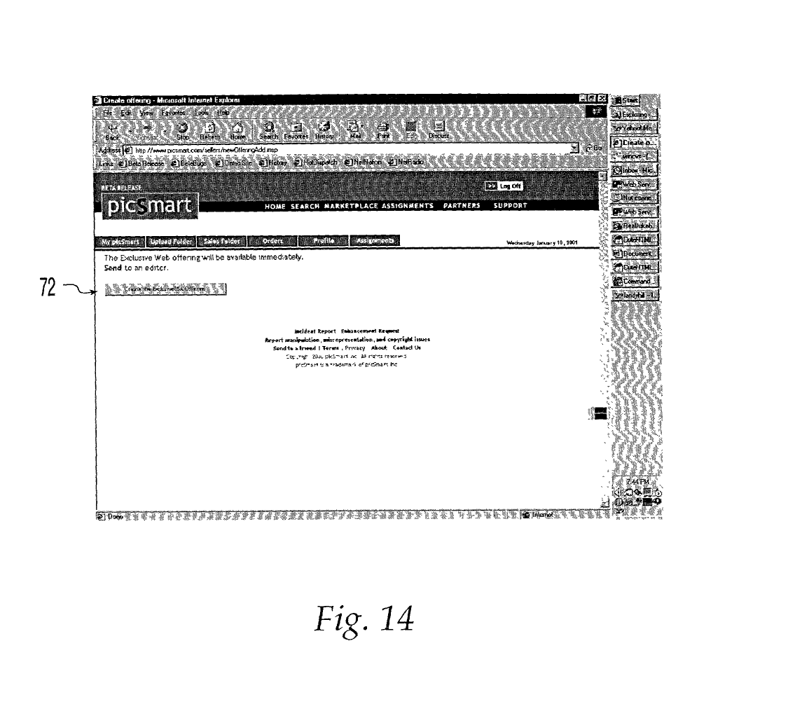

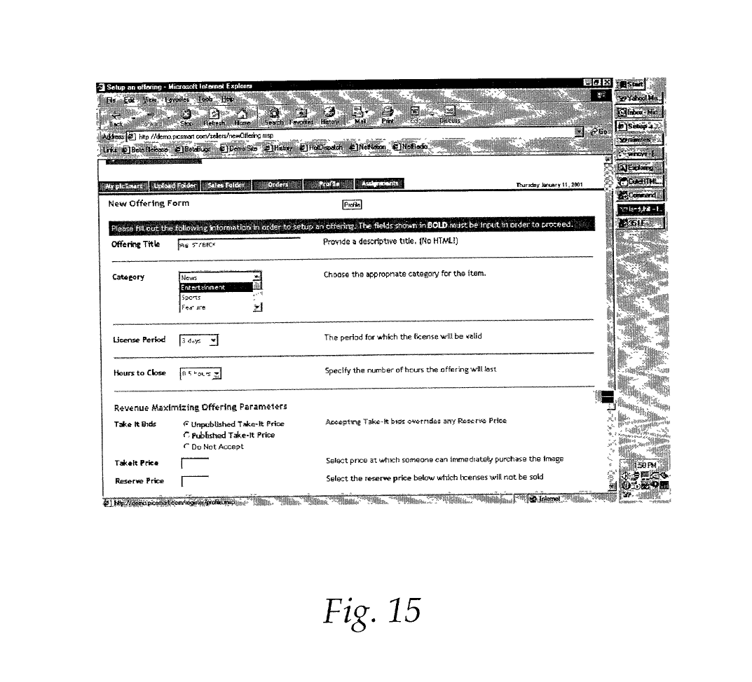

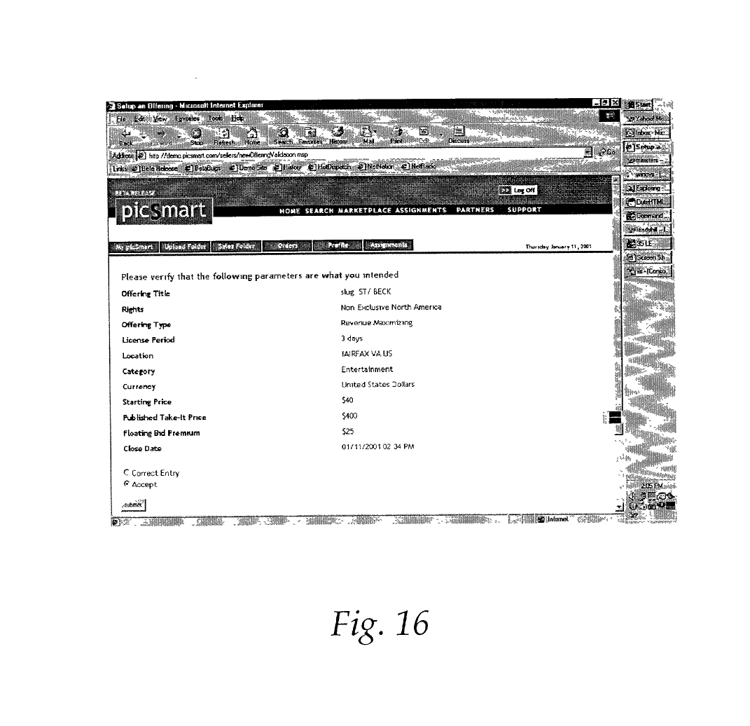

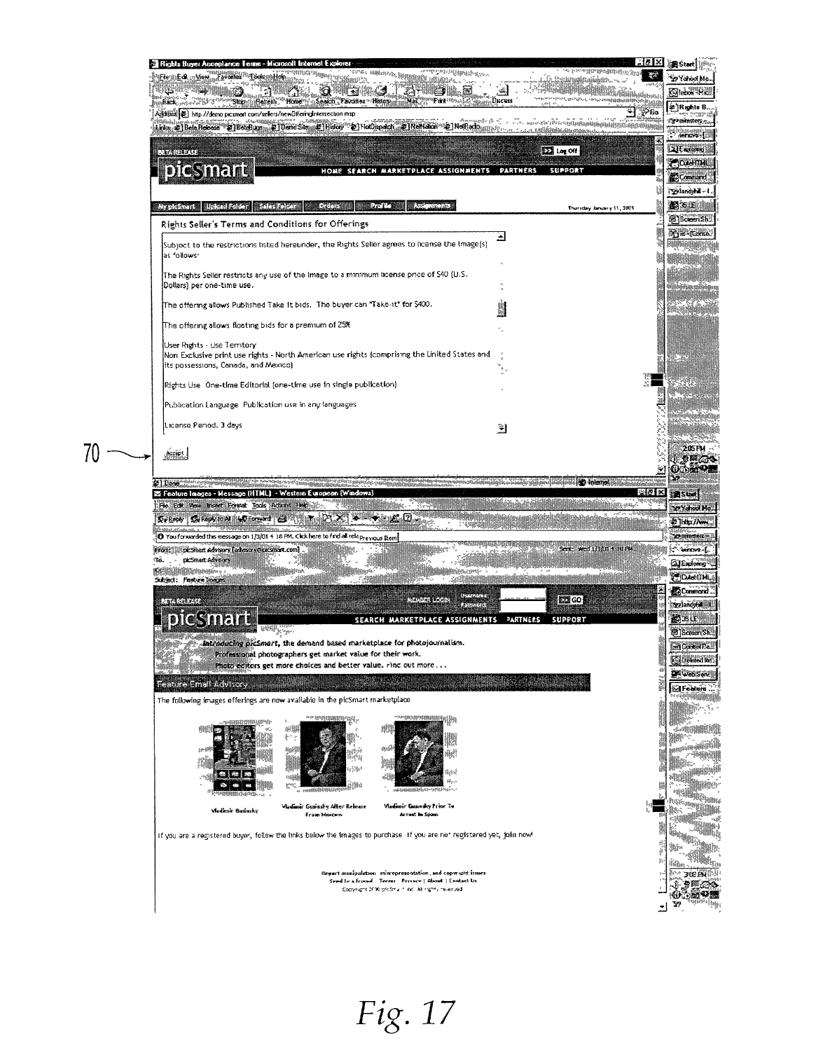

FIG. 4 is an exemplary web page which confirms the uploaded image 34 and information 36 that was placed in a sales folder. FIG. 5 is an exemplary web page which in menu or menus 38 asks the seller to select different groups of rights to offer for sale, for example offering exclusive and non-exclusive rights. FIG. 6 is an exemplary web page which asks the seller to further select in menu 40 the selected non-exclusive rights offered, provided the nonexclusive rights option was selected in FIG. 5, by geographic location/type of media and to select a pricing option. There are also advantageously menu 42 which allow the seller to exit the process and menu 44 which allows the seller to select the other category, for example exclusive rights. FIG. 7 is an exemplary web page which asks the seller to provide further information on the sale of rights, including, for example, a minimum price and a starting price in menu 46 if the demand curve price option is selected, and also in menu 48 to further define the rights offered by defining the duration of the license offered. There may be other menus, for example menu 50 allowing the seller to select identifiers which will help a buyer find the image. FIG. 8 is an exemplary web page which asks the seller in menu 52 to further define a “take-it” or “reserve” price where the buyer can take the image without waiting for the bid period to expire, as well as menu 54 allowing input of further identifiers regarding the image and menu 56 specifying licence and/or offer parameters. The title of the image is advantageously displayed in 58, and may allow the seller to switch between images. FIG. 9 is an exemplary web page which asks the seller to set a fixed price in input 60, if the fixed price option was selected. FIG. 10 is an exemplary web page which is similar to FIG. 6 but asks the seller in menu 62 to further select the selected exclusive rights offered by geographic location, type of media, language, and the like, and may ask the seller to select a pricing option. FIG. 11 is an exemplary web page which asks the seller to set terms for an auction, for example in menu 68 to choose hour many hours to let a revenue-maximizing process proceed. FIG. 12 is an exemplary web page which summarizes for the seller the terms for a demand-curve type offering, providing a menu 70 for the seller to accept or decline. FIG. 13 is an exemplary web page which informs the seller about specific contract terms, providing a menu 70 for the seller to accept, i.e., to confirm and actually place the offer. FIG. 14 is an exemplary web page which provides a short-cut menu 72 for a often-used pricing strategy, in this case to offer exclusive rights in the United States. FIG. 15 is an exemplary web page much like FIG. 8 but for another image, as a seller can have multiple images in his/her sales folder. FIG. 16 is an exemplary web page much like FIG. 12 but for another image, and for nonexclusive rights, selecting the revenue-maximizing sales option. FIG. 17 is an exemplary web page which defines license parameters for a floating bid, providing a seller the option to accept the terms in menu 70.

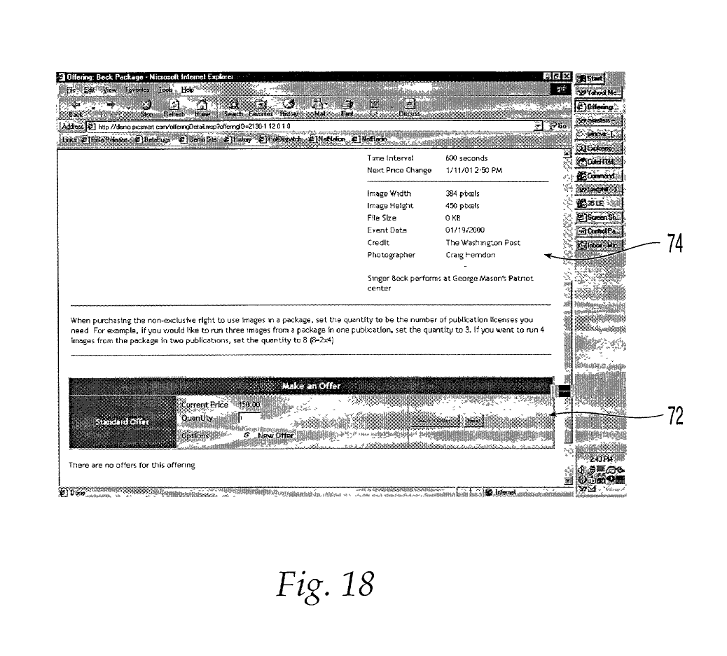

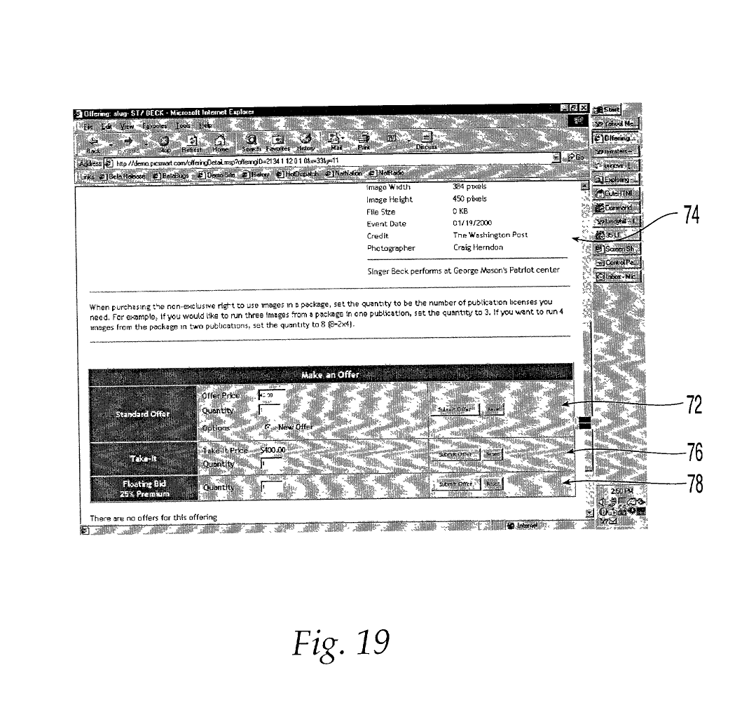

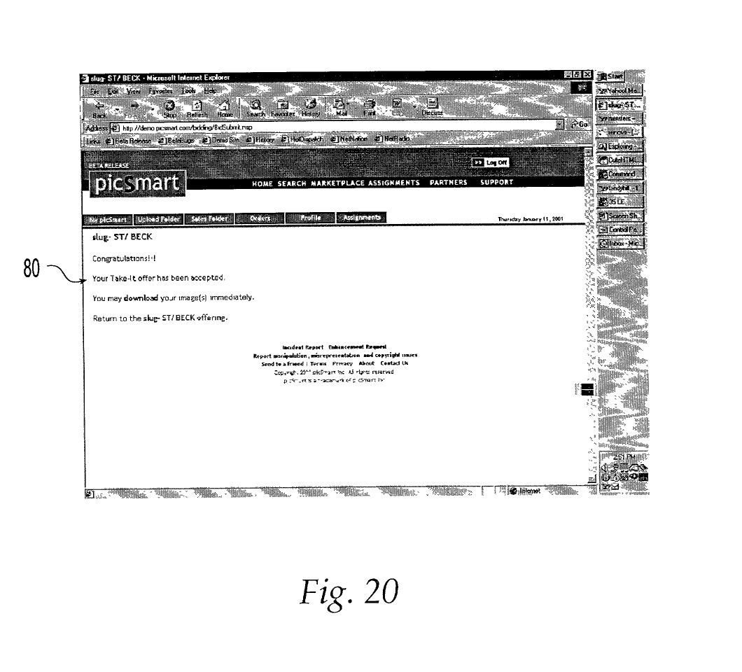

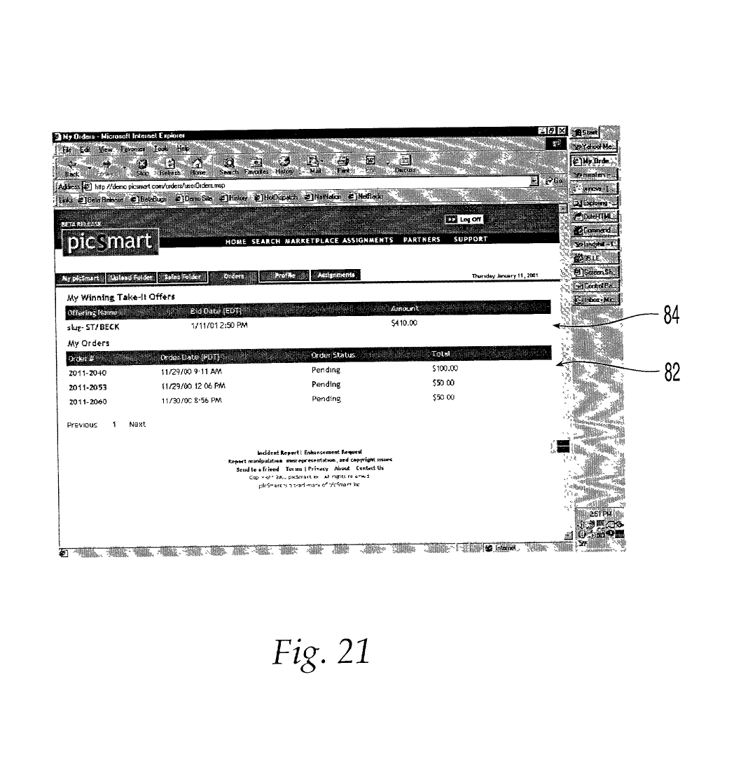

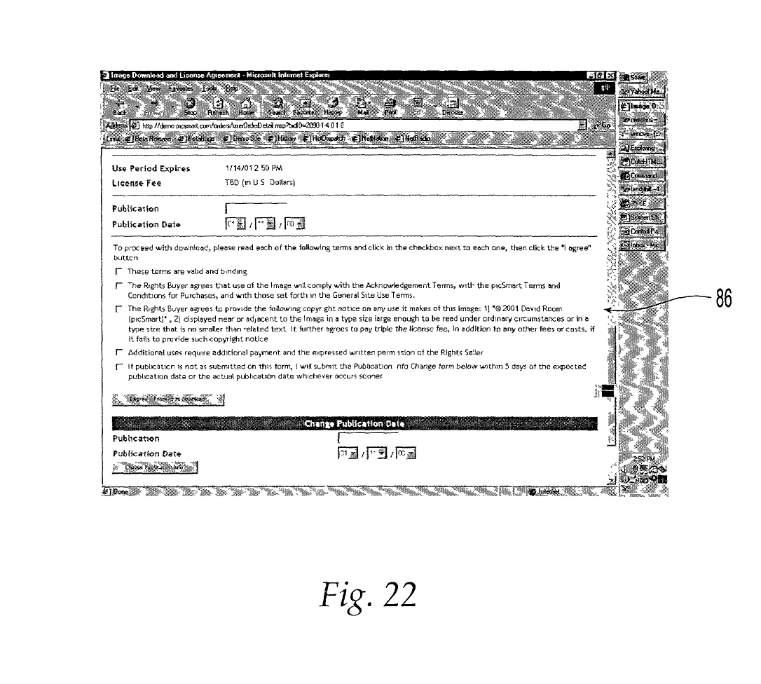

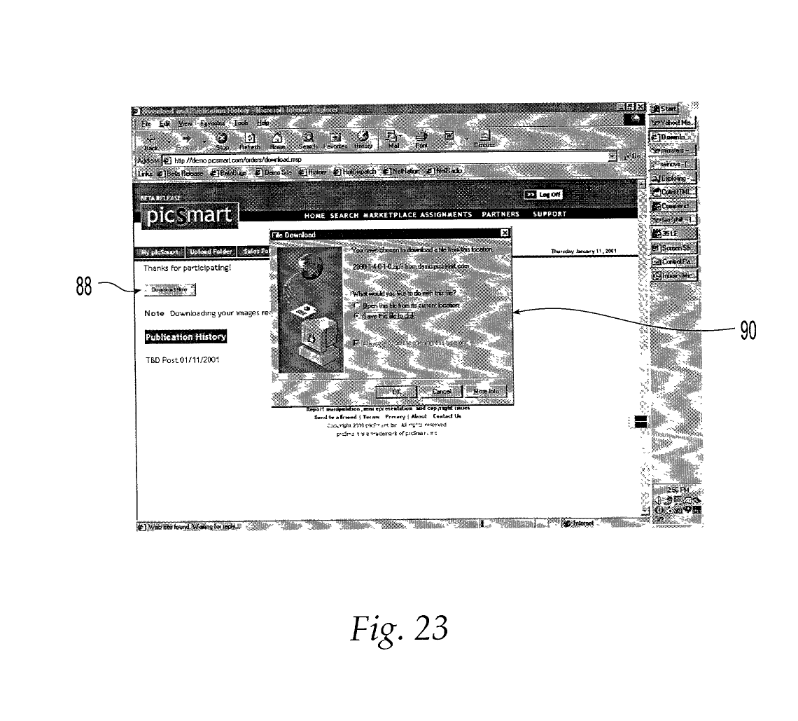

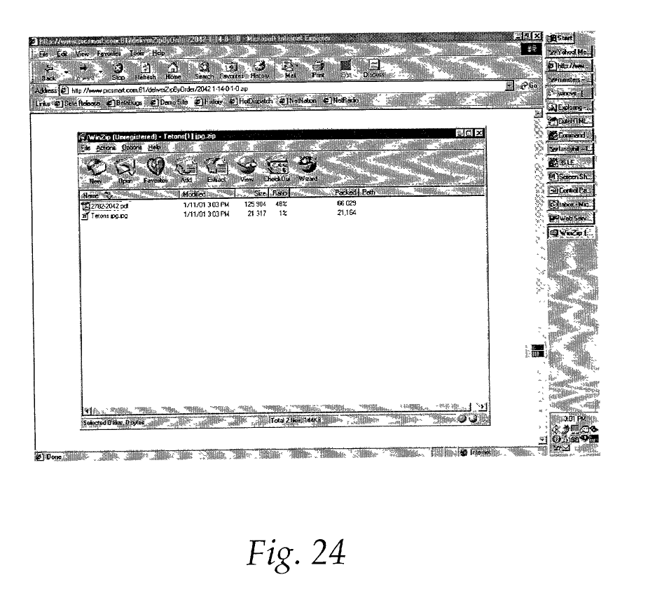

FIG. 18 is an exemplary web page wherein a buyer submits, via menu 72, an offer for a non-exclusive right to use an image. Included are details about the image in box 74. FIG. 19 is an exemplary web page which continues from FIG. 18 and shows other bidding options, including a take-it bid offer in input 76 and a floating bid in box 78. These boxes require the buyer to input the quantity of licenses desired and, where appropriate, the price. If a buyer needs non-exclusive rights to a image before the end of the bidding period, the buyer submits an special offer for a non-exclusive right to use an image, for example a take-it bid, or a floating bid where the buyer agrees to pay a premium over the final price to get the image immediately, as well as a standard price offer. FIG. 20 is an exemplary web page wherein a buyer is informed that the offer was accepted, and provides a link 80 so the buyer can download the image immediately. FIG. 21 is an exemplary web page wherein a buyer can keep track of the status of several pending and accepted offers, displaying in box 82 information about pending orders, such as when the bid was placed and the amount of each bid. In box 84, similar information about an accepted bid is presented. FIG. 22 is an exemplary web page wherein a buyer agrees to the terms of the license and downloads the image. In box 86 there are several boxes where contract terms are displayed and which require affirmative input from the buyer to accept the terms. FIG. 23 is an exemplary web page containing a menu wherein the buyer can download the image, as well as a message 90 from the buyer's computer regarding saving the downloaded image to the buyers computer. FIG. 24 is a depiction of the buyers computer display showing the saved image.

Magazine-quality digital images taken, for instance, by digital cameras, can be transferred in this manner. It is these digital images stored in electronic form, and the rights inherent to these images, which later become the subject of a bidding process.

As used herein, the terms “photograph”, “picture”, and “digital images” are used interchangeably and include, for example, a picture that is a portion of an original picture that has been cropped, or altered in a manner that the substance of the original picture is substantially visible, for example, a picture intentionally blurred or digitally altered or a picture with other objects added thereto, or a picture included in a larger work, for example, a montage.

As used herein, the term “buying” or “bidding on” a digital image means buying or bidding on one of the transferable rights in the digital image. Typically, when a buyer successfully purchases a transferable right, for example a right to publish subject to certain conditions, the electronic marketplace conveys to the buyer, or provides access to, a file containing the image in machine-readable form.

As used herein, a “buyer” of a digital image is a person or entity which receives a license of a right to publish or otherwise use, and if with an exclusive license also the right to prevent use, of the image.

As used herein, the term “auction house” means the “electronic marketplace”.

As used herein, the term “seller” means a party who has transferrable rights in the image, and is preferably an entity that has all rights in the use of the image.

Buyers for these digital images, such as editors at various publications such as newspapers, news magazines, and the like, beneficially also register with the auction house and execute the necessary forms. Such forms may solicit payment information, who the buyer represents, the geographic area the buyer is interested in, the circulation of the buyer's media, and the like. Once registered, the registered buyers are then allowed to bid on rights to the digital images.

The digital images offered for auction can be found via an internet browser on a webpage belonging to the electronic market's web site. The registered buyers can view a representation, for example thumbnail sketches of these digital images, preferably at no cost, and selectively bid for the right to display the digital images under specified terms and conditions. In a preferred embodiment, either the image provided for review is of insufficient quality to publish, and/or there are other technologies in place, to prevent a party from downloading and publishing a photograph without having paid for the right. Typically, after the sale or auction process is over, the digital images are provided electronically to registered buyer or buyers who won the auction or the demand-based pricing structures as described herein.

The buyer can search for images using a search engine and keywords. In response to a directed search, for example, a search for pictures of the inaugural speech in Washington, D.C., the display may include 1) a webpage containing multiple images from different sellers that match the search parameters, or 2) the names of sellers in whose sales folder is at least one image that match the search parameters, or 3) a plurality of images from a seller's sales folder that contains at least one image that matches the search parameters.

In one embodiment of the invention, a buyer receives the asset, for example the digital image of the picture and the right to publish same, before the end of the bidding process. Such buyers may wish to receive the image in time for a deadline, for example, and can not wait for the auction to end. In such a case, the buyer who receives early rights must agree to pay a premium, for example 20% to 50% over the final auction price for non-exclusive rights, or a premium over the highest bid for exclusive rights, or the greater of the two. Such a early release automatically, of course, prevents granting an exclusive right to any other party for that geographic location.

Payments are beneficially made electronically, too. The auction winners pay for their purchases electronically, and corresponding payments or portions thereof as defined by contract are then forwarded to the photographers whose works have been sold. To facilitate payments and collections, arrangements for electronic transfers are made during the registration process. Discounts to buyers for immediate payment and charges to photographers for factoring, if they require immediate resources, can also be arranged for. In a preferred embodiment, a pre-determined percentage of the auction proceeds, say 30%, is retained by the auction house for the service it provides the photographers. Alternatively, the auction house may charge the auction winners a pre-determined premium, say 20%, for the service.

In a preferred embodiment, the right to be auctioned and/or sold is the intangible right to display a digital image, such as a photograph, illustration, graphic, video, or the like. A digital image is typically stored as a electronic file in a predetermined format, such as JPEG, although other formats, such as GIF, TIFF, PNG, BMP, FlashPIX, PNM, EPS, RDF, FITS, NITF and DICOM, among others, may be used instead. The digital image can be a scanned negative or print from a conventional camera, a photograph taken with a digital camera, or be from any number of other sources. What is important is that the digital image, at some time, be in electronic format, perhaps supplied with a watermark to help keep track of its electronic history, and that the image be of sufficient size and resolution for a newspaper to publish.

Without loss of generality, the digital image in the present specification is considered to be newsworthy and have journalistic merit, having been taken by a photographer who is a photojournalist. The status of the photographer/seller is established by the electronic marketplace, with the seller indicating his/her professional or non-professional status, and also his/her affiliations with journalistic organizations, for example NPPA or ASMP, along with a list of published works and references. The Electronic Market may verify the information. This information may be provided to buyers and potential buyers who may wish to give one particular seller an assignment.

Once the seller is registered, the seller, i.e., the photographer, his associate, or agent uploads the digital image, via telephone, radio, cable, cellular wireless, or the like, to a first computer. Alternatively, the submission may be a photograph, disk or negative that is mailed in and subsequently scanned or otherwise converted to digital form on the first computer. From this first computer, the digital image is ultimately transferred to a host server and metadata are stored in a host database, either under the control of an auction house or a third party having an arrangement with the auction house. It should be noted, however, that the digital image may be uploaded directly to auction house via the internet, rather than being first transferred to the first computer. This first upload is beneficially in a Upload Folder. Along with the image, or at a later time, the seller conveys instructions to place the image in the Sales Folder, that is, to place the rights to the image in an offering, and also which bundle or bundles of rights the seller wishes to allow potential buyers to bid on. Preferably, the bundle of rights can be selected from a menu, for example, selecting worldwide, North America, Europe, Asia, and Rest of the World as standard geographic divisions; next two days, next two weeks, and after two weeks as standard temporal divisions; and exclusive, nonexclusive, or a combination thereof as a definition of the exclusivity of the rights offered.

Advantageously, the electronic marketplace offers both normal and secure servers. The secure server access may require a surcharge. Advantageously, the image is uploaded as a jpeg file. Advantageously, the seller owns all rights to the image, and the image has not entered the public domain. Advantageously, the image must be real and authentic and must portray the people/place/event.

The Electronic Marketplace advantageously offers guidelines on the original asking price, the various sales and auctioning methodologies, and the like. The seller selects what type of sale to offer based on the seller's view of the newsworthiness, that is, potential value, of the image. Potential types of sale include fixed price offering, momentum-based pricing, an upward auction, or a downward auction, and others as described herein.

Upon receiving the digital image, along with information identifying the photographer or other source of the digital image, the auction house catalogs the digital image and stores it on a file server or in a database. Preferably, the auction house is connected to the internet via one or more server computers. The auction house also has a web site which provides an electronic marketplace for auctioning and/or selling the right to such digital images for display, primarily in the news media.

Potential buyers, that is, parties interested in obtaining display rights, can electronically submit bids to the auction house which then processes the bids and determines which parties get to display the digital image, and under what terms such displays may be made.

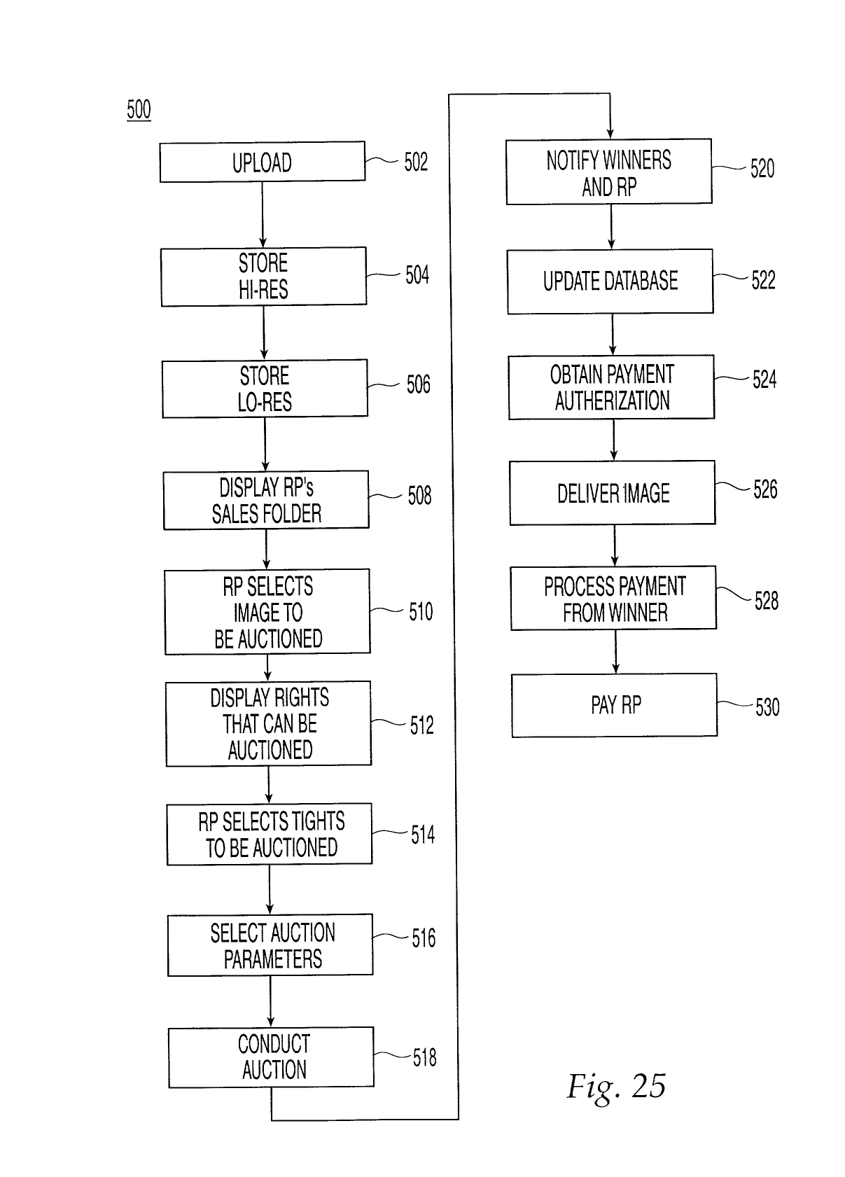

FIG. 25 presents a flow chart 500 of a preferred embodiment for the steps involved in bringing a digital image into the hands of a buyer, such as a newspaper editor. In step 502, using a web interface, a registered photographer (RP) uploads a high resolution digital image to his or her online portfolio at the auction house's web site and specifies an image name along with other identifying information. The identifying information preferably includes such things as the date and time the photograph was taken and also keywords to help identify the image. The keywords may include geographical identifiers to designate where the picture was taken (“Laguardia Airport”) object identifiers to explain the items depicted (“survivors”) and perhaps also an event identifier indicating the nature or circumstances of the occurrence (e.g., “plane crash”). This information facilitates a subsequent search by, say, an editor who seeks certain photographic subject matter for the issue of his or her publication.

In step 504, the high-resolution photo is stored in a directory for high-resolution images on the image server for with a unique file name, derived from a sequential counter, the RP's identifying information, or a combination of the two. In step 506, a compression tool automatically generates a low-resolution image which is saved to a directory for low resolution images for that RP with the same, or with a related, file name. The low-resolution image is the one that is displayed as a thumbnail image to prospective buyers.

In step 508, a list of the image names in the RP's sales folder is displayed, and in step 510 the RP selects one of these to place in an offering. The selected image may be the one that was most recently uploaded, in which case step 508 may be skipped with the RP working only with the most recently uploaded image. At step 512, the RP is shown a form which displays the available rights that can be auctioned (subject to any rights for the selected image which previously had been auctioned off). At step 514, the RP selects the rights that they would like to auction for the selected image, and this can include all remaining rights. At step 516, a form displays auction parameters such as type of auction, start date and time, end date and time, starting bid, reserve price, etc., and the RP enters his or her selections.

At step 518, the auction proceeds and concludes, as determined by the auction parameters. Upon conclusion, at step 520, the auction participants and RP are notified of the results by e-mail. At step 522, information is updated in the database indicating which rights have been sold, as well as documenting the details of the auction conclusion. At step 524, if payment from the auction winner requires authorization, such authorization is obtained.

At step 526, the image is provided to the winner bidder(s). The image can be provided in a number of ways including e-mail, ftp, other electronic means, or possibly even regular mail. If, for example, the winning bidder's profile specifies e-mail for image delivery, the high resolution image is sent to the winner's e-mail address, preferably as an attachment. If, on the other hand, the winning bidder's profile specifies ftp for image delivery, the winner is sent a secure ftp address by e-mail and the winner can then retrieve the high resolution image. Yet another way to provide the high-resolution image is for a bidder to log onto the web site and access his account. The bidder can view all bids he made on a particular digital image, and the status of those bids. If the bidder won any digital images in the auction, these will be indicated. Hyperlinks may be provided to the winning images, thereby allowing a winning bidder to directly download the high-resolution image from the web site along with a license document. Regardless of how the high-resolution image is provided to the winning bidders, at step 528, the winner's payment is processed or otherwise captured, at some point after notification, retrieval, or other distribution of the high-resolution image. Finally, at step 530, payment is made to the RP.

It should be evident to one skilled in the art that the above sequence of steps does not have to be conducted in precisely the stated order. Furthermore, it should also be evident that some of the steps need not always be conducted, and that additional steps may also be executed.

The display right associated with a digital image can be broken up into a set of categories which are offered for sale by the auction house. A very simple set of categories is created by partitioning the display right of a digital image into either (a) unlimited exclusive rights to display the digital image, or (b) unlimited non-exclusive rights to display the digital image. In such case, the categories are mutually exclusive since one cannot sell both exclusive and non-exclusive unlimited rights at the same time.

The rights to display an image may be divided in a number of other ways, too, which are independent of exclusivity. One way to divide the rights is in terms of the number of times the image may be “run” in publications. Thus, the offerer may allow bidders to bid on a “one time” display right, an “X number of times” display or “unlimited” display right. A “buyout”, or right to both use and resell, may also be sold.

Another way to divide the rights is to designate the geographical areas in which the image may be displayed. For example, separate rights may be sold for North America only, Europe only, Rest of the World, or Global. One skilled in the art can see that a virtually unlimited number of combinations involving various countries, and even regions of countries, are possible.

Yet another way to divide the rights is temporally. For example, the right to display an image within the next 24 hours (when it's newsworthy) may be separated from rights to display the image during one or more subsequent time periods.

Yet another way to divide the rights is to separate them into the language of the general medium in which the image appears. For example, a photograph of an event in Martinique, may be primarily of interest to the French-speaking world and so the right to display the image in French-language newspapers, magazines, web sites and the like, may be separated from the right to display the same image in other language medium.

One skilled in the art can readily see that the above approaches to divide the rights to display an image can be combined, giving one a large number of possible rights that theoretically can be offered. As a practical matter however, the selection of rights to be offered is preferably limited to a handful of commercially useful and practical ways in which display rights can be separated. Thus, a small mixture of exclusive and non-exclusive rights during varying time periods, in different geographical limitations, different types of media, and so forth may be advantageous.

In one embodiment, there are pre-selected selections, for example the geographic areas provided above, for each division of rights, and the pre-selected selections are displayed in menu format for the buyer to select. For example, the right to display a digital image may be broken up into (a) unlimited exclusive rights worldwide forever, (b) exclusive rights to display the digital image within 24 hours in print media, i.e., paper or magazine, in each of the U.S., Europe and the rest of the world; (c) non-exclusive rights to display the digital image within 24 hours in print media in each of the U.S., Europe and the rest of the world; (d) non-exclusive rights to display it on the internet and/or on television for a period of two weeks; and (e) non-exclusive rights to display it on the internet for a period of four weeks. In this modestly complicated case, some of the categories overlap, while others are mutually exclusive.

Prospective buyers of the right to display a digital image can visit the web site to view images that are for sale, and the rights being offered. The images may be cataloged in various ways, including by geographical area to which the digital image pertains, photographer name, subject matter, etc. The Electronic Marketplace provides search mechanisms to facilitate finding the image of interest. For particularly newsworthy items, the electronic marketplace advantageously alerts registered potential buyers by, for example, email, of the current or pending sale. The email may contain the low resolution version of the image, along with notification that the recipient can only get rights to publish the image by successfully bidding at the electronic marketplace. The registered buyers can pre-specify their advisory preferences.

At the web site, the prospective buyer preferably can view only a thumbnail sketch of the digital image, so as to discourage stealing what is displayed. Winners of the auctioning process would later either be sent the full-size image, or would be given special access to download the full-size image from a server, or other suitable computer which can access the full-size image.

Advantageously, the successful bidders/purchasers of licenses in the rights, particularly in one or more Copyright rights, must give notice via a copyright notice. Unless special permission is granted, the buyer can not make any alteration, distortion, or corruption of the image other than normal cropping and insertion of a legible copyright notice. Unless special permission is granted, the license is particular to the buyer and may not be assigned or transferred.

In a preferred embodiment, the set of auction or sale categories for a digital image is established by the auction house, often with input from the seller. This provides some consistency in the types of rights that prospective buyers can expect to obtain, and consistency in how the photographers can expect to be compensated. It should be noted, however, that the present invention also contemplates the photographer establishing the set of the display rights for auction. Also contemplated is that the buyer suggests a new display right category to be added to the pre-existing set of categories. Regardless of how the auction categories for a particular digital image are established, the objective of the auction house's auctioning algorithm preferably is to maximize some criterion. And this can be realized using a number of different auction/sales paradigms.

Non-competitive Pricing with Non-conflicting Rights

If a particular image is not particularly newsworthy, the seller may wish to sell exclusive or non-exclusive rights by fixed pricing. In such a case, the seller pre-selects the price for the respective rights.

Competitive Pricing with Non-conflicting Rights

Exclusive Display Right−English Ascending

If all that is being offered at auction is an unlimited exclusive display right of a digital image, the auction algorithm simply chooses the highest bidder. In such case, the highest bidders' bid is the auction price and the highest bidder is the only one who gets to display the image, in accordance with the terms of display agreement. This auction is typically referred to as an “English Ascending” auction, since the bids increase price during the course of the auction and the highest bidder wins all the rights that are available. The highest price may or may not be displayed.

Non-exclusive Display Right−Revenue Maximizing

In general, the “available quantity” of a non-exclusive display right is unlimited. If all that is being offered is non-exclusive display right of the digital image, the “Revenue Maximizing” algorithm tries to maximize the revenue from selling to multiple bidders, at the bid price offered by the lowest of the winning bidders. The Revenue Maximizing algorithm can be defined as follows:

Let:

J=the number of bidders

I=total number of unique bids, I≦J

p₁=price of the ith highest bid, i=1, 2, . . . I, with p₁>p₁₊ₗ for i=1, 2, . . . , I−1

q₁=number of bidders bidding price p₁

Q₁=number of bidders bidding price p₁ or greater

TRₘ=total revenue for the mth highest bid.

To maximize revenue, select sales price pₘ so as to maximize TRₘ over all m=1, 2, . . . , I, where

$${TR}_{m} = {p}_{m} {\sum }_{i = 1}^{m} {q}_{i} \qquad ( Eq . 1 )$$

and sell the image to a total of

$${Q}_{m} = {\sum }_{i = 1}^{m} {q}_{i}$$

bidders, who bid at least price pₘ.

To use this embodiment, sellers list a minimum price and a duration of the offer, buyers offer a price at or above the listed minimum price, the successful bid price is selected by determining, at the close of the offer period, the maximum revenue from all buyers offering at or above the successful bid wherein all winning bidders pay the lowest successful bid price. This is similar to a Dutch auction. This process can be short-circuited, for example by a buyer who has a deadline that expires before the end of the auction period, by allowing for Take-it pricing, that is, a price established by the seller where the buyer gets immediate rights, and by allowing for Run-it pricing, wherein the buyer agrees to pay a premium over the selected price at the conclusion of the bid period.

### EXAMPLE 1

Revenue Maximizing

The revenue maximizing auction algorithm can be demonstrated with a simple example. If parties A, B, C, D, E an F (J=6) offer bids of $100, $80, $60, $58, $56 and $15 (I=6), respectively, the choices are:

(1) sell to A at $100 (m=1, p₁=$100, Q₁=1, TR₁=$100);

(2) sell to A & B at $80 (m=2, p₂=$80, Q₂=2 TR₂=$160);

(3) sell to A, B & C at $60 (m=3, p₃=$60, Q₃=3, TR₃=$180);

(4) sell to A, B, C & D at $58 (m=4, p₄=$58, Q₄=4, TR₄=$232);

(5) sell to A, B, C, D & E at $56 (m=5, p₅=$56, Q₅=5, TR₅=$280); or

(6) sell to A, B, C, D, E & F at $15 (m=6, p₆=$15, Q₆=6, TR₆=$90).

Since option (5) yields the greatest total revenue ($280), it would be selected by the Revenue Maximizing algorithm. In such case bidders A, B, C, D and E each receive display rights, while bidder F receives no display rights.

### EXAMPLE 2

Revenue Maximizing−Tie in Revenue

In the case where two or more such combinations yield the same maximum revenue, the Revenue Maximizing algorithm preferably selects that combination having the largest number of winners. Thus, in the above example, if option (4) were to sell to A, B, C & D at $70 (m=4, pₘ=$70, Q₄=4, TR₄=$280), the algorithm would still have selected option (5), because five (rather than four) bidders would be winners. Alternatively, some other rule, such as the lowest number of winners, or other criterion, may be used as a ‘tie-breaker’.

In some instances, a bidder may want to order multiple ‘copies’ of a non-exclusive right. An example of this might be when the bidder wishes to publish the digital image in, say, three separate magazines, and the right being offered is for publication in just one magazine. In such case, the concept of a ‘quantity requested’ by each bidder must be taken into account. For this, in the definitions associated with Eq. 1, q₁ simply represents the total number of units (rather than the number of bidders) requested at price pᵢ and Q₁₃ represents the total number of units (rather than the number of bidders) requested at price p₁ or higher.

Alternatively, one can define additional terms and new equations as follows to accommodate a ‘quantity requested’ by each bidder:

Let bⱼ indicate the price bid by bidder j, j=1, 2, . . . , J

Let xⱼ indicate the number of rights (‘quantity’) requested by bidder j, j=1, 2, . . . , J

Then, to maximize revenue, select sales price pₘ so as to maximize TRₘ over all m=1, 2, . . . , I, where

$${TR}_{m} = {\sum }_{j = 1 , {b}_{j} \geq {p}_{m}}^{J} ( {x}_{j} * {p}_{m} ) \qquad ( Eq . 2 )$$

The rights are then sold to the bidders whose bid price bⱼ≧pₘ.

And in the special case where each bidder only requests 1 copy (xⱼ=1, j=1, 2, . . . , J), Eq. 2 reduces to selecting sales price pₘ so as to maximize TRₘ over all m=1, 2, . . . , I, where

$${TR}_{i} = {\sum }_{j = 1 , {b}_{j} \geq {p}_{m}}^{J} ( {p}_{m} ) \qquad ( Eq . 3 )$$

and the rights are again sold to the bidders whose bid price bⱼ≧pₘ.

### EXAMPLE 3

Revenue Maximizing−Multiple Copies

The “Revenue Maximizing−Multiple Copies” algorithm can be demonstrated with an example. If parties A, B, C, D, E an F (J=6) offer bids of $100, $80, $60, $58, $56 and $15 (I=6), respectively, with B requesting 8 copies, the choices are:

(1) sell to A at $100 (m=1, p₁=$100, x₁=1, TR₁=$100);

(2) sell to A & B at $80 (m=2, p₂=$80, x₂=8, TR₂=$720);

(3) sell to A, B & C at $60 (m=3, p₃=$60, x₃=1, TR₃=$600);

(4) sell to A, B, C & D at $58 (m=4, p₄=$58, x₄=1, TR₄=$638);

(5) sell to A, B, C, D & E at $56 (m=5, p₅=$56, x₅=1, TR₅=$672); or

(6) sell to A, B, C, D, E & F at $15 (m=6, p₆=$15, x₆=1, TR₆=$195).

Since option (2) yields the greatest total revenue ($720), it would be selected by the Revenue Maximizing algorithm. In such case bidders A and B each receive display rights, while the remaining bidders receive no display rights. This case is effectively the same as if 8 separate bidders (call them B₁, B₂, . . . , B₈) had each bid $80.

In the above discussion, the price offered by the bidders was used to determine the candidate groupings of bidders. Thus, in the foregoing examples, the nth candidate grouping comprised the n highest bidders. It should be kept in mind, however, that the candidate groupings may be formed in other ways, such as being on a function f(p₁) of each of the bid prices. The function f( ) may be a linear function, such as a scalar multiplying each bid price, an affine transformation of each bid price, or some other nonlinear function. The function may even include parameters which depend on some characteristic of the bidder.

For example, if one wished to take into account not only the price offered by each bidder, but also each bidder's circulation, each bid could be scaled by the corresponding bidder's circulation to form a new parameter cⱼ=bid price of bidder j/circulation of bidder j. Then, the parameter c_{J} would be used as the basis of comparison to form the candidate groupings. In such case, the algorithm tests out the maximum revenue at the unique values of cj (amount bid per unit of circulation), and selects the winners based on those that have c_{J}'s greater than the tested value. The winning price, then, is given in amount per copy circulated and the total revenue would be the total number of copies sold at the winning price. This is best illustrated through an example.

### EXAMPLE 4

Revenue Maximizing—Price per Circulation Copy

Parties A, B, C, D, E, F (J=6) offer bids of pᵢ={$100, $80, $60, $58, $56 and $15} (I=6) and their circulations are 100, 40, 60, 116, 224, 10 units, respectively. Their bid amount/unit circulation is then cⱼ={$1, $2, $1, $0.5, $0.25, $1.5}, respectively. Under these conditions, the candidate groupings are:

(1) sell to B only at c₂=$2.00/circulation copy, (TR=$2.00×(40)=$80)

(2) sell to B & F at c₆=$1.50/circulation copy, (TR=$1.50×(40+10)=$ 75)

(3) sell to A, B, C, & F at c₁, c₃=$1.00/circulation copy (TR=$1.00×(100+40+60+10)=$210).

(4) sell to A, B, C, D & F at c₄=$0.50/circulation copy (TR=$0.50×((100+40+60+116+10)=$163);or

(5) sell to A, B, C, D, E & F at c₅=$0.25/circulation copy (TR=$0.25×((100+40+60+116+224+10)=$137.50).

In this example, option (3) would be selected because it yields the greatest revenue and so bidders A, B, C and F would obtain the rights.

Competitive Pricing with Conflicting Rights

Exclusive+Non-Exclusive Revenue Maximizing

If both an unlimited exclusive display right and a one-time non-exclusive display right are being offered, the auction algorithm selects whichever yields the highest revenue and the corresponding winner(s) obtain the display right accordingly. An exemplary list of rights that may be offered include:

Exclusive rights to publish in one or more geographic locations,

Exclusive rights to publish during one or more time periods;

Exclusive rights to publish a certain number of publications, i.e., a certain number based on circulation, and/or based on duplications, i.e., a certain number of editions;

Exclusive rights to publish in a certain medium, for example, newsprint, television, or internet-based dissemination;

Exclusive rights to publish in a certain language;

Non-exclusive rights to publish in each of the above-listed categories; and

Subsets of the above rights defined by combining the above categories.

Sub-Optimal Exclusive+Non-Exclusive Revenue Maximizing

While the default is that the auction algorithm selects the combination of winners which results in the highest revenue, the photographer may establish criterion which may result in less-than-maximum revenue. For example, the photographer might wish to specify that a non-exclusive display right yielding a predetermined proportion c, say 75%, of the exclusive display right, would take precedence over the exclusive display right. This might be done if the photographer thinks he or she can sell display rights to others at some later date. In such case, the auctioning algorithm effectively weights the calculated revenue from the unlimited exclusive auction by the factor c. In addition to such weighting parameters, the photographer may also establish minimum monetary parameters such as a reserve price or a reserve total revenue, thereby sometimes forgoing any sale. Finally, the photographer may also establish buyer criterion, such as refusing to sell to particular buyers for his or her own reasons.

Complex Conflicting Rights

The Complex Conflicting Rights format is designed for simultaneously auctioning multiple conflicting rights. The rights handled in this paradigm may be divided into any number of ways and include both exclusive and non-exclusive rights. When such complicated combinations of categories of display rights are offered simultaneously, a buyer is free to bid on any number of these and place bids only on those categories in which that buyer is interested. The winners are selected based on the set of non-conflicting rights that maximizes revenue, subject to the constraints imposed by the photographer.

The exclusive rights are prioritized by the website revenue maximizing subprogram. The rights are put into a hierarchy, where each descending layer is a set of subsets of the right above, and where a successful bid in a right above the hierarchal right makes rights below that un-saleable. For example, selling exclusive rights globally precludes selling in the next subdivision, for example North America or Europe. Selling exclusive rights in North America does not preclude selling rights in Europe, because Europe is not a subset of North America. Similarly, selling exclusive rights precludes selling exclusive rights up that branch of the hierarchy. For example, selling exclusive rights in France precludes selling exclusive rights in Europe. However, this does not preclude selling rights in a different branch. For example, one can not sell exclusive rights in France and also in Europe, but if you move to a different branch, say Spain, the sale of exclusive rights is not precluded. Such sale of exclusive rights within the same branch where other exclusive or non-exclusive rights creates conflicting rights. Similarly, selling non-exclusive rights in any portion of branch of the hierarchy prohibits selling exclusive rights within that same branch. Logically, if nonexclusive rights are placed below the same exclusive rights before branching, one tree of rights are created. If exclusive rights are sold to any “parent”, using a family analogy to the rights tree, no rights can be sold to any “child” or “parent” of the parent. For each node, the bids are evaluated and maximum revenue is calculated. Then, the non-conflicting nodes that result in the greatest revenue, using the tree logic, is calculated. The selection of choices that provides maximum revenue with no conflicting rights is then selected.

If a specific non-exclusive right has already been sold (or is undergoing an auction), the corresponding exclusive rights cannot be offered. If a specific exclusive right has already been sold (or is undergoing an auction), the corresponding non-exclusive rights cannot be offered. Preferably, a starting price, a reserve price, a minimum bid increment, an auction start time and an auction end times are set for each exclusive and non-exclusive right. Generally speaking the auction start and end times will be the same for both exclusive and non-exclusive rights, when are being offered. In a preferred embodiment, for exclusive rights, the starting price and the minimum bid increment are set by the photographer, while the auction house may specify these items for non-exclusive rights.

Once the auction opens, bidders bid on the specific rights they desire. The non-exclusive rights operate using the Revenue Maximizing algorithm while the exclusive rights operate using the English Ascending variable increment auction whereby the highest bidder wins, or a Vickrey-type auction, whereby the highest bidder pays the second-highest price bid. At the close of the auction, the potential winners are determined for each of the rights offered. From this pool of potential winners, the set of potential winners with non-conflicting rights that maximizes revenue receive the various rights. In the case where the algorithm is indifferent between sets of winners, it will default to selling non-exclusive rights so as to maximize the number of winners. Alternatively, some other rule, such as the lowest number of winners, or other criterion, may be used as a ‘tie-breaker’.

The operation of the Complex Conflicting Rights paradigm may be illustrated with an series of hypothetical outcomes from an example using a fixed set of complex rights. In this example, the rights to display an image are divided into the following groupings:

(1) Exclusive Global

(2) Exclusive USA, Europe, Other

(3) Non-Exclusive USA, Europe, Other

Example 5 -- Complex Conflicting Rights

| | |
|---|---|
| Bids: | Bidder 1 bids $1000 Non exclusive USA |
| | Bidder 2 bids $700 Non exclusive USA |
| | Bidder 3 bids $400 Non exclusive Europe |
| | Bidder 4 bids $200 Non exclusive Europe |
| | Bidder 5 bids $100 Non exclusive Other |
| | Bidder 6 bids $600 Exclusive USA |
| | Bidder 7 bids $300 Exclusive Europe |
| Outcome: | Bidders 1, 2 win Non-Exclusive USA right. The assigned |
| | price is $700 each |
| | Bidders 3, 4 win Non exclusive Europe right. the |
| | assigned price is $200 each |
| | Bidder 5 wins Non exclusive Other right. The assigned |
| | price is $100. |
| Total revenue | |
| is $1900. | |

Example 6 -- Complex Conflicting Rights

| | |
|---|---|
| Bids: | Bidder 1 bids $1000 Non-exclusive USA |
| | Bidder 2 bids $700 Non-exclusive USA |
| | Bidder 3 bids $400 Non-exclusive Europe |
| | Bidder 4 bids $200 Non-exclusive Europe |
| | Bidder 5 bids $100 Non-exclusive Other |
| | Bidder 6 bids $600 Exclusive USA |
| | Bidder 7 bids $300 Exclusive Europe |
| | Bidder 8 bids $450 Exclusive Europe |
| | Bidder 9 bids $50 Exclusive Other |
| Outcome: | Bidders 1, 2 win Non-exclusive USA right. The assigned |
| | price is $700 each |
| | Bidder 8 wins Exclusive Europe right. The assigned |
| | price is $450 |
| | Bidder 5 wins Non-exclusive Other right. The assigned |
| | price is $100. |
| Total revenue | |
| is $1950. | |

Example 7 -- Complex Conflicting Rights

| | |
|---|---|
| Bids: | Bidder 1 bids $1000 Non-exclusive USA |
| | Bidder 2 bids $700 Non-exclusive USA |
| | Bidder 3 bids $400 Non-exclusive Europe |
| | Bidder 4 bids $200 Non-exclusive Europe |
| | Bidder 5 bids $100 Non-exclusive Other |
| | Bidder 6 bids $600 Exclusive USA |
| | Bidder 7 bids $300 Exclusive Europe |
| | Bidder 8 bids $450 Exclusive Europe |
| | Bidder 9 bids $50 Exclusive Other |
| | Bidder 10 bids $2050 Exclusive Global |
| Outcome: | Bidder 10 wins Exclusive Global right. The assigned |
| price is $2050. | |
| Total revenue | |
| is $2050. | |

### EXAMPLE 8

Complex Conflicting Rights

On occasion, a bidder who bids for an exclusive right, may bid an amount that is more than the amount bid by at least one of the other bidders for the corresponding non-exclusive right, and still lose the auction because the total revenue from selling non-exclusive right is greater than that from selling the exclusive right. For instance, in Example 5 above, if bidder 6 bids $1200 for Exclusive USA rights, he still would lose to bidders 1 and 2 (both of whom bid less than $1200, but are willing to obtain non-exclusive rights only). Bidder 6 would also lose if he bid $800, which is higher than the amount bid by bidder 2 (and thus higher than the final price for the non-exclusive right) but less that than the amount bid by bidder 1. This scenario arises when the auction is closed—i.e.., when no bidder can see the amounts that the other bidders have bid or what all rights they are bidding on. One possibility in this instance is to allow bidder 6 to participate in obtaining the non-exclusive display right at the price that it is offered to the others, perhaps at a premium.

While the above discussion focuses on items of interest to photojournalists and their customers, and the auction algorithm discussed above is directed to auctioning rights in displaying digital imagery, it should be kept in mind that the auctioning algorithm can also be applied to intangible property other than those associated with a copyright in a digital image. For instance, the auctioning algorithm of the present invention may also be applied to rights in videographic information stored and distributed as an MPEG, AVI, QUICKTIME or other type of video file, audio information stored as a RAM, MP3, WAV, SWF or other type of audio file, written material such as novels, jokes, songs, and a whole host of other copyrightable material.

It should be kept in mind that the auctioning algorithm of the present invention also may be applied to non-copyrightable intangible property and to options in tangible property.

In the case of a trademark, the owner can offer the trademark for exploitation in a number of categories including: (1) outright transfer of the trademark; (2) exclusive license for unlimited use within the registered trademark class (or classes); (3) various exclusive licenses for particular goods and services, e.g., for T-shirts, for hats, for coffee cups, etc.; and (4) non-exclusive licenses for such items. Bids would be received in one of more of these four categories, and that combination resulting in maximum revenue would be chosen.

In the case of a patent, the patent owner can offer the patent for licensing on various terms, in addition to offering it for an outright sale. For example, the auction set for a patent may include categories such as: (1) outright assignment of the patent; (2) exclusive license everywhere and in all fields of use; (3) various exclusive licenses for one or more of the different combinations of fields of use and geographical areas, and (4) non-exclusive licenses. Bids would be received from each of several buyers in one or more categories, and the combination of licenses resulting in maximum revenue to the patent owner would be chosen, and the assignment or licenses would thus be determined.

The auctioning algorithm invention can also be applied to settings in which there is more demand than supply for a tangible item. For example, assume that a luxury car manufacturer announces that a new car model would be introduced in six months and that only a limited number of cars would be available. The car manufacture would become a client of the auctioneer, and would guarantee delivery of the vehicles to individuals designated by the auction house. In return, the auction house would provide a cut of the options proceeds to the car manufacturer. Each bidder would guarantee to take delivery of a car, if his or her bid was accepted. The auction house would then solicit bids for the right to purchase the car at the manufacturer's suggested retail price. The auction algorithm would then be used to determine both the number of cars to be produced, and the identity of the winning bidders, each of whom would pay the manufacturer's suggested retail price plus the option price bid by the lowest person. Services may also be auctioned on a non-exclusive basis to try to maximize revenue. Thus, an airline may wish to sell some of its seats on a given flight using such an auction algorithm.

The auction algorithm of the present invention can be used in conjunction with a sealed bidding process in which no bidder knows what any other bidder has bid. In such case, each bid is submitted blindly, with each bidder having no idea how many others are bidding, for which categories of rights they are competing, or how much each has bid.

Alternatively, the present invention can also be used in conjunction with an “open” auction in which each bidder is provided with some current bid information about the bids which have previously been made. The current bid information can include such things as the identity of the previous bidders, the categories in which each previous bidder has made a bid, or the identity of the winners of the exclusive and the non-exclusive auctions. The current bid information may comprise the bid amounts themselves. For instance, the current highest bid for the exclusive categories may be displayed. For the non-exclusive categories, one may display the highest current bid price, the lowest bid required to assure that non-exclusive bidders would all receive the right, or even all bids received, although such postings are likely to reduce the amounts bid by future bidders.

Non-competitive Pricing Schemes

Non-competitive methods for dynamically pricing intangible property rights on a non-exclusive basis may also be employed to sell display rights. These can be used in addition to, or in place one or more of the auctioning schemes described above.

Fixed Price

If a particular image is not particularly newsworthy, or is common and therefore is not in high demand, or for some other reason, the seller may wish to sell exclusive or non-exclusive rights by fixed pricing. In such a case, the seller pre-selects the price for the respective rights.

Offer to Circumvent Auction—“Take A Guess”

The “Take A Guess” system is a way for a buyer/bidder to obtain the display right regardless of any auction that is either underway or planned. In this paradigm, the photographer specifies a target price for a particular right—this is the price that the photographer would accept, if one were to offer to buy the right outright. A photographer specifies the target price (or, target prices, if they are specified for both exclusive and non-exclusive rights) at the time the photographer chooses to offer the corresponding right for sale, and this target price is kept secret. The secrecy is needed so that the bidding can potentially go higher than the target price, if no offers are made to “take” the display right.

The purpose of providing a “Take A Guess” option is to allow a buyer/bidder a chance to obtain the right to display the image, even if the auction has not yet started or is underway. For example, if an auction is slated to close at 5 pm on a given day, and an editor has a 4 pm deadline the editor can make an offer to “take a guess”. If the offer exceeds the target price, the editor obtains the display right being auctioned so that he can meet his deadline, and the auction is closed. If the offer falls short of the target price, the offer is rejected and the auction continues. Preferably, each buyer/bidder is allowed only one chance to make an offer to display a particular image. This limitation is imposed so as to prevent a buyer from “fishing” for the target price by incrementally upping the offer until it meets the target price.

Offer to Guarantee Right—“Take It”, or Floating Bid

The “Take It” or Floating Bid option is offered when non-exclusive rights are being offered. This option guarantees a bidder the right so long as anyone else receives non-exclusive rights. However, to obtain a guaranteed right, the bidder will have to pay a premium over the final price at which the non-exclusive rights are sold. The premium can be a percentage above the final price, a fixed amount over the price, or a combination of the two—e.g., $100+50%, among others. The premium may be taken into account in calculating the expected revenue, such as in the “revenue maximizing” algorithm. Preferably, the right (e.g., a digital image to be displayed) will be given to the requester as soon as the “take it” option is exercised, with the price perhaps determined at the conclusion of the auction.

In a preferred embodiment, the “take it” option is provided to the bidders in a non-exclusive auction after a predetermined event has taken place. The predetermined event may be the receipt of a predetermined number of bids, predetermined bid price, or other criterion. In the case of a complex rights auction, the “take it” option may only be made available at the conclusion of the auction, when it has become clear that the right will be sold on a non-exclusive basis, rather than on an exclusive basis.

Momentum-Based Pricing—“Demand Curve or Early Bird”

The “Demand Curve or Early Bird” approach of pricing non-exclusive display rights on a non-competitive basis is an example of a dynamic pricing methodology that allows the price to track market demand. In this non-competitive pricing method, the initial price and the minimum prices are set by the seller, and then the price of an item increases each time the item (license) is sold and decreases if no sale has been made in a predetermined time period, subject to the minimum price. Of course, modifications such as having no change if a selected goal number have been sold in a predetermined time limit, an upward change if more than the goal number have been sold in a predetermined time limit, and a downward change if less than the goal number have been sold in a predetermined time limit, are possible. In one embodiment, a range of numbers of sales for no change in price can also be set. The price change can be by a fixed amount, by a variable amount, by a percentage, or any combination thereof. This algorithm results in an increasing price if there is strong demand for the item and a decreasing price, if market demand declines. The early bird pricing algorithm is given as follows:

| | | |
|---|---|---|
| Let: | P = | sales price of an item |
| | Pₘᵢₙ = | Minimum sales price for an item (must be > 0) |
| | Pₘₐₓ = | Maximum sales price for an item (can be infinity, in |
| | | which there is no maximum) |
| | Pₛₜₐᵣₜ = | Starting sales price of the item (can be the same as |
| | | Pₘᵢₙ) |
| | P_{inc} = | Amount by which the sales price increases each time |
| | | there is a sale of the item |
| | T = | Current time |
| | Tₒₚₑₙ = | Time that item is first offered for sale |
| | T_{close} = | Time that item is last offered for sale (can provide for |
| | | item is always offered) |
| | T_{inc. =} | Time interval |
| | P_{dec} = | Amount by which the sales price decreases each time |
| | | no sale has been made for time period T_{inc} |
| | S_{inc-up} = | Threshold sales quantity that must, in one |
| | | embodiment, be reached for upward pricing increments |
| | | to occur |
| | S_{inc-no} = | Range of threshold sales quantity that must, in one |
| | | embodiment, be reached for no pricing increments to |
| | | occur |
| | S_{inc-down} = | Threshold sales quantity that must, in one |
| | | embodiment, be reached for downward pricing |
| | | increments to occur |

An item is initially offered for sale at the starting price of P=Pₛₜₐᵣₜ. Each time the product is sold, or a sales threshold is met, there will be a price increase: P<——P+P_{inc} subject to the criterion that P≦Pₘₐₓ. Price changes can occur at the time the threshold is met, or at some pre-determined time interval. Each time there is a change in price, a timer is reset. If the timer counts up the T_{inc}, the price is decreased by P_{dec}. Therefore, if the most recent price change was longer than time period T_{inc} ago, then there is a price decrease: P<——P−P_{dec} subject to the criterion that P≧Pₘᵢₙ. The Early Bird pricing algorithm is now illustrated using the following parameters:

Pₘᵢₙ=$100

Pₘₐₓ=∞

Pₛₜₐᵣₜ=$120

P_{inc}=$10

P_{dec}=$20

T_{inc}=1 hour

Tₒₚₑₙ=9:00 am

(1) At T=9:00 am, the item is first offered for sale at P=$120;

(2) At T=9:10 am, the item is purchased at P=$120 and the price changes to P=$130;

(3) At T=9:12 am, the item is purchased at P=$130 and the price changes to P=$140;

(4) At T=10:00 am, the item is purchased at P=$140 and the price changes to P=$150;

(5) At T=11:00 am no sale has been made since 10:00 am and the price changes to P=$130;

(6) At T=12:00 pm no sale has been made since 11:00 am and the price changes to P=$110;

(7) At T=1:00 pm no sale has been made since 12:00 pm and the price changes to P=Pₘᵢₙ=$100;

(8) Three weeks later, the item is purchased at P=$100 and the price changes to P=$110;

The Early Bird algorithm can use variable values for P_{inc}, P_{dec} and T_{inc} instead of fixed values. For example, the price increment P_{inc}, can accelerate with each sale or with time so that each subsequent offering price differs by an increasing amount. For example, the price increment P_{inc} may equal $10 after the first sale, $20 after the second sale, $30 after the third sale, etc., and perhaps be reset to $10, if there is ever a decrement. A similar scheme may be used for the price decrement P_{dec}. And instead of a changing the increment or decrement by a fixed dollar amount, the increment may change by a percentage. As to the time interval T_{inc}, this can be varied either by a fixed amount (e.g., lengthen or shorten the time between successive reductions by, say 15 minutes) or by a percentage (e.g., lengthen or shorten the time between successive reductions by, say 25% —in the case of lengthening the time, 1 hour before the first decrement, 1:15 before the second decrement, etc., and in the case of shortening the time, 1 hour before the first decrement, 45 minutes before the second decrement, etc.).

In addition to the above variations, the Early Bird algorithm may also allow for a bidder to specify the quantity that the bidder wants. The quantity specified may also affect the next price at which the item is offered. For example, if the price is currently $100 and the price increment p_{inc} is nominally $10, a bidder asking for one unit will cause the next offering price to rise to $110. However, a bidder asking for three units at $100 may cause then next offering price to climb to, say, $130 (an increment of 3×$10). It should be evident to one skilled in the art, however, that a variety of price adjustment schemes which are responsive to quantity requested, may be employed.

While the above examples focus on display rights, especially those for digital images, it should be kept in mind that the same principles apply to auctioning virtually any type of non-exclusive intangible rights, such as patent and trademark licenses and licenses to copyrightable subject matter. Also, while the above invention has been described with reference to certain preferred embodiments, it should be kept in mind that the scope of the present invention is not limited to these. One skilled in the art may find variations of these preferred embodiments which, nevertheless, fall within the spirit of the present invention, whose scope is defined by the claims set forth below.

What is claimed is:

1. A method of selling display rights in a digital image, comprising:
receiving at least one digital image from each of a plurality of sellers;
transmitting a version of at least one digital image to a plurality of bidders;
offering for sale at least one category of available display rights representing a scope of use of the digital image;
receiving a plurality of bids for said at least one category of display rights;
determining at least one buyer, based on said plurality of bids; and
transmitting the digital image to said at least one buyer.

2. The method of claim 1, wherein
said at least one category comprises an exclusive right to display the digital image; and
said buyer is determined based on the highest bid received.

3. The method of claim 1, wherein
said at least one category comprises a non-exclusive right to display the digital image; and
said at least one buyer is determined by calculating a maximum revenue from selling to a one or more of the bidders at the bid price offered by the lowest of said at least one buyer.

4. The method of claim 1, further comprising receiving from each seller information which define the rights under which a seller may display the digital image.

5. The method of claim 1, wherein a plurality of categories of available display rights are offered, and the categories comprise at least one first category comprising an exclusive display right and at least one second category comprising a non-exclusive display right;
the method further comprising receiving at least one bid for each of said first and second categories; and
comparing a winning bid for selling the display right on an exclusive basis with a total amount of revenue to be received by selling the display right on a non-exclusive basis at the bid price offered by the lowest of the successful bids; and
determining said at least one buyer based on the outcome of the comparison.

6. The method of claim 1 wherein the available display rights representing a scope of use of the digital image comprises a plurality of: exclusive rights to display in printed or electronic media within a specific geographic location, exclusive rights to display in printed or electronic media during one or more time periods; exclusive rights to display in printed media in predetermined number of publications; exclusive rights to display in media of a certain language; or combinations thereof.

7. The method of claim 1 wherein the available display rights representing a scope of use of the digital image comprises a plurality of: non-exclusive rights to display in printed or electronic media within a specific geographic location, non-exclusive rights to display in printed or electronic media during one or more time periods; non-exclusive rights to display in printed media in a predetermined number of publications; non-exclusive rights to display in media of a certain language; or combinations thereof.

8. The method of claim 7 wherein the available display rights representing a scope of use of the digital image comprises both exclusive and non-exclusive rights, wherein at least some of the offered rights are conflicting rights, wherein there are one or more bids on at least one pair of conflicting rights, and wherein the buyer or buyers are determined by the electronic marketplace and are the bidder or bidders of non-conflicting rights that result in the greatest revenue.

9. A method of selling display rights in a digital image, comprising:
receiving at least one digital image from each of a plurality of sellers;
transmitting a version of at least one digital image to a plurality of bidders;
offering for sale at least one category of non-exclusive display rights representing a scope of use of the digital image comprises;
transmitting a price of the non-exclusive right;
receiving a plurality of bids from buyers for said at least one category of display rights;
changing the price by a preselected amount depending on the quantity sold within a preselected time interval; and
transmitting the digital image to buyer whose bids were accepted.

10. The method of claim 9 wherein
the price increases by a first preselected amount if a first preselected quantity of bids are accepted within a preselected time interval; and
the price decreases by a second preselected amount if a second preselected quantity of bids are not accepted within a preselected time interval, and stopping decreasing the price when a preselected minimum price is displayed.

11. The method of claim 9 wherein the first preselected quantity does not equal the second preselected quantity, wherein the price does not change if the number of bids accepted is between the first preselected quantity and the second preselected quantity.

12. The method of claim 9 wherein the display rights offered for sale comprises a plurality of: non-exclusive rights to display in printed or electronic media within a specific geographic location, non-exclusive rights to display in printed or electronic media during one or more time periods; non-exclusive rights to display in printed media in a predetermined number of publications; non-exclusive rights to display in media of a certain language; or combinations thereof.

13. A method of selling display rights in a digital image, comprising:
receiving at least one digital image from each of a plurality of sellers;
transmitting a version of at least one digital image to a plurality of bidders;
offering for sale at least one category of available display rights representing a scope of use of the digital image, wherein said at least one category comprises an exclusive right to display the digital image;
receiving a plurality of bids for said at least one category of display rights;
determining the buyer based on the highest bid received; and
transmitting the digital image to said at least one buyer.

14. The method of claim 13 wherein the available display rights representing a scope of use of the digital image comprises a plurality of: exclusive rights to display in printed or electronic media within a specific geographic location, exclusive rights to display in printed or electronic media during one or more time periods; exclusive rights to display in printed media in predetermined number of publications; exclusive rights to display in media of a certain language; or combinations thereof.

15. A computer for selling rights in a digital image, said computer containing software and being adapted to:
receive a digital image from a plurality of sellers;
allow access by a plurality of potential bidders;
transmit a version of the digital image to the plurality of bidders and a message offering for sale a plurality of available display rights, each representing a scope of use of the digital image;
receive a plurality of bids for said at least one display right;
determine at least one buyer, based on said plurality of bids; and
transmit the digital image to said at least one buyer.

16. The computer of claim 15, wherein said plurality of available display rights comprises at least one non-exclusive right to display the digital image, said computer and software being further adapted to:
accept a plurality of bids on the nonexclusive right;
determine the successful bidder or bidders by maximizing revenue obtained by selling to all bidders at the price offered by the lowest bidder.

17. The computer of claim 15, wherein said plurality of available display rights comprises at least one exclusive right to display the digital image and at least one non-exclusive right to display the digital image, said computer and software being further adapted to:
accept a plurality of bids on a nonexclusive right;
accept a plurality of bids on an exclusive right;
compare the revenue from each combination of non-conflicting bids; and
identify at least one successful buyer or buyers of non-conflicting rights that provides maximum revenue from selling the non-exclusive rights at the bid price offered by the lowest of said at least one successful buyer of non-exclusive rights and/or from selling to one or more buyers non-conflicting exclusive rights.

18. The computer of claim 15, wherein the available display rights representing a scope of use of the digital image comprises a plurality of:
exclusive rights to display in printed or electronic media within a specific geographic location;
exclusive rights to display in printed or electronic media during one or more time periods;
exclusive rights to display in printed media in predetermined number of publications;
exclusive rights to display in media of a certain language; or
combinations thereof.

19. The computer of claim 15, wherein the available display rights representing a scope of use of the digital image comprises a plurality of:
non-exclusive rights to display in printed or electronic media within a specific geographic location;
non-exclusive rights to display in printed or electronic media during one or more time periods;
non-exclusive rights to display in printed media in a predetermined number of publications;
non-exclusive rights to display in media of a certain language; or
combinations thereof.

20. A method of buying display rights in a digital image, comprising:
accessing, with a computer, an electronic marketplace via the internet:
receiving, on the computer, a display version of the digital image from the electronic marketplace;
receiving, on the computer, an offer for sale of at least one category of available display rights representing a scope of use of the digital image;
transmitting, from the computer and to the electronic marketplace, at least one bid for said at least one category of display rights;
obtaining at least one display right; and
receiving the digital image.

21. The method of claim 20 wherein the available category of display rights representing a scope of use of the digital image comprises at least one of exclusive rights to display in printed or electronic media of a specific geographic location, exclusive rights to display in printed or electronic media during one or more time periods; exclusives right to display in printed or electronic media in predetermined number of publications; or combinations thereof; and
at least one of non-exclusive rights to display in printed or electronic media of a specific geographic location, non-exclusive rights to display in printed or electronic media during one or more time periods; non-exclusive rights to display in printed media in a predetermined number of publications; or combinations thereof.

22. The method of claim 20 wherein there is a bidding period, further comprising transmitting a bid whose value will be determined at a future time based on a premium over the winning bid at the conclusion of the bidding period, wherein the rights and image are received prior to the end of the bidding period.
